(19) United States
(12) Patent Application Publication
(10) Pub. No.: US 2015/0134308 A1
(43) Pub. Date: May 14, 2015

(54) METHOD AND DEVICE FOR ACQUIRING OPTIMIZATION COEFFICIENT, AND RELATED METHOD AND DEVICE FOR SIMULATING WAVE FIELD

(71) Applicant: Institute of Geology and Geophysics, Chinese Academy of Sciences, Chaoyang District (CN)

(72) Inventors: Jinhai Zhang, Beijing (CN); Zhenxing Yao, Beijing (CN)

(21) Appl. No.: 14/117,307

(22) PCT Filed: Nov. 5, 2012
(86) PCT No.: PCT/CN12/84083

§ 371 Date: Nov. 12, 2013

(30) Foreign Application Priority Data
Sep. 14, 2012 (CN) 201210343161.1

(51) Int. Cl. G01V 1/28; G06F 17/50

(52) U.S. Cl. CPC G01V 1/28; G06F 17/5018
USPC 703/2

(57) ABSTRACT

It is provided a method and a device for acquiring optimization coefficients, and a related method and device for simulating a wave field. Determining whether the values of a discrete variable Kₓ(i) in the finite difference scheme controlled by the current temporary coefficients {Bₙ} meet a first condition, the current temporary coefficients {Bₙ} meeting the condition are selected and are added into a result to be selected; searching for a maximum current discrete value of the discrete variable Kₓ(i) in the finite difference scheme controlled by the current temporary coefficients {Bₙ} with the maximum current discrete value satisfying a condition that the values of the discrete variable Kₓ(i) meet the first condition to determine an accuracy coverage range, and selecting a set of current temporary coefficients {Bₙ} having the maximum accuracy coverage range as the first-type optimization coefficients {bₙ}, the first-type optimization coefficients {bₙ} are found to serve as the optimization coefficients.

This application claims the priority of Chinese Patent Application No. 201210343161.1, entitled “METHOD AND DEVICE FOR ACQUIRING OPTIMIZATION COEFFICIENT, AND METHOD AND DEVICE FOR SIMULATING RELATED WAVE FIELD”, filed with the Chinese Patent Office on Sep. 14, 2012, which is hereby incorporated by reference in its entirety.

### FIELD OF THE INVENTION

The present invention relates to the field of geophysical exploration, and particularly to a method and device for acquiring optimization coefficients, and a related method and device for simulating a wave field.

### BACKGROUND OF THE INVENTION

Seismic wave changes with time and space, and in the wild environment, a measured seismic signal of seismic wave in the environment may be obtained by a detector. For example, blasting or knocking produces an initial excitation signal, and locations where the blasting or knocking happens are seismic source points, and detectors are placed at some space points on the ground surface or placed on a side wall of a well, so as to obtain a measured seismic signal at the location where the detectors are located. Seismic wave field simulation can be used to obtain simulation records for detectors in the wild. The space distribution of seismic propagation velocity is changed continuously, such that finally the simulation records obtained by the seismic wave field simulation coincide with the measured seismic signal, thus achieving the purpose of understanding actual properties of mediums under the ground by simulating, on a computer, wave phenomenon in mediums around a seismic source point.

Therefore, the seismic wave field simulation is of great importance in studying a seismological problem related to the wave phenomenon, and plays an important role in individual operation stages of seismic exploration and seismology, and thus is applied in acquisition, processing, and interpretation of seismic data, and various links in an underground resource development engineering. A high-accuracy seismic wave field simulation helps people understand the seismic propagation rule in a complex exploration target, and solve various problems in underground mineral resource exploration and development.

Seismic wave field simulation includes seismic exploration reverse time migration imaging, full waveform inversion, seismic wave simulation and the like, which are on the basis of a wave equation. The finite difference method, in which a space partial derivative and a time partial derivative of a wave field function in the wave equation is replaced by a corresponding space difference and a corresponding time difference, is one of main methods for implementing seismic wave field simulation. For example,

taking finite difference discrete of a second-order space partial derivative of a wave equation as an example, the finite difference discrete performed on the second-order space partial derivative of a certain continuous function ƒ(x), actually refers to performing the following Taylor expansion at x=0:

$$\frac{{\partial }^{2} f}{\partial {x}^{2}} \approx \frac{1}{{Δ}^{2}} {\sum }_{n = - N / 2}^{N / 2} {a}_{n}^{N} [ - \frac{2}{{n}^{2}} cos ( n π ) ] {f}_{n}$$

in the above equation, an even number N is the order of the Taylor expansion in a finite difference scheme, Δ is a space grid spacing in x direction, and aₙ^{N} is a conventional coefficient defined by a binomial formula as follows:

$${a}_{n}^{N} = ( \begin{matrix}N \\ \frac{N}{2} + n\end{matrix} ) / ( \begin{matrix}N \\ \frac{N}{2}\end{matrix} )$$

Since the Taylor expansion has limitations such as local expansion and slow convergence, its main drawback is that there exists stronger numerical dispersion noise for data having wider frequency range, and the numerical dispersion noise will directly influence the accuracy of seismic wave field simulation. In an actual application, in order to reduce the influence of the noise as far as possible, there mainly exist two ideas now.

(1) Adopting higher-order Taylor expansion, i.e., adding a higher-order correction item. Referring to FIG. 1, the curve shown in the Figure is a common means for evaluating performance of a seismic wave field simulation method, where the abscissa is a discrete variable wave number range and the ordinate is an absolute error range; it is generally recognized that, the larger the discrete variable wave number span in the abscissa that a smaller absolute error corresponds to, the larger an accuracy coverage range of the method is, and the smaller the influence from the numerical dispersion error is. As shown in the Figure, the higher the order of the Taylor expansion is, the higher the accuracy is. However, this idea has a main drawback: the effect is weak, and resulting in multiplied calculation amount, and this increasing of the calculation amount is usually catastrophic for seismic wave field simulation having huge data and frequent iterations, such as seismic migration imaging, waveform inversion and the like. Although the numerical dispersion problem may be alleviated by reducing the space grid spacing Δ, memory requirements in this case would be multiplied, which often makes it difficult for a large-scale three-dimensional space model to be performed under the existing computer condition.

(2) Directly reducing the dominant frequency of an original signal, i.e., eliminating higher frequency components through filtering to meet severe requirements of the finite difference method. The main drawback of this idea is that, the processing resolution is reduced directly because high frequency component is an indispensable effective component for improving the resolution.

### SUMMARY OF THE INVENTION

In view of this, a major object of the present invention is to provide a method and device for acquiring optimization coefficients, and a related method and device for simulating wave field, to achieve the purpose of improving the accuracy of seismic wave field simulation by acquiring optimization coefficients having a wider accuracy coverage range to replace the conventional coefficients of a finite difference and using the optimization coefficients to control the finite difference scheme.

According to the present invention, it is provided a method for acquiring optimization coefficients, and the method includes:

an initialization step, a calculation step, a checking step, an acquisition step, an interference step, and an output step, herein,

the initialization step includes:

setting a value of an error limit T;

setting an initial value of a current discrete value; and

setting an output condition of the optimization coefficients;

the calculation step includes:

randomly generating at least one set of current temporary coefficients {Bₙ}, herein, Bₙ⁰≦Bₙ≦Bₙ¹, Bₙ¹ is a floating upper limit preset for Bₙ, Bₙ⁰ is a floating lower limit preset for Bₙ, and wherein the number of Bₙ in the current temporary coefficients {Bₙ} is decided by the order N that is adopted by a finite difference scheme;

the checking step includes:

determining whether values, from 0 to the current discrete value, of a discrete variable Kₓ(i) in the finite difference scheme controlled by the current temporary coefficients {Bₙ} each meets a first condition;

herein, the first condition is that a difference E between an ideal value and an actual value is less than or equal to preset the error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of the space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;

if it is determined that the values, from 0 to the current discrete value, of the discrete variable Kₓ(i) in the finite difference scheme controlled by the current temporary coefficients {Bₙ} meet the first condition, entering the acquisition step;

if it is determined that the values, from 0 to the current discrete value, of the discrete variable Kₓ(i) in the finite difference scheme controlled by the current temporary coefficients {Bₙ} do not meet the first condition, entering the interference step;

the acquisition step includes:

adding the current temporary coefficients {Bₙ} into a first-type result to be selected; and

acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, herein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;

the interference step includes:

determining whether the output condition of the optimization coefficients is met; and

if the output condition of the optimization coefficients is not met, adjusting the current temporary coefficients {Bₙ} on a current basis of the current temporary coefficients {Bₙ}, herein the values of the adjusted current temporary coefficients {Bₙ} are in a range from the floating upper limit to the floating lower limit preset for {Bₙ}; and updating the current temporary coefficients {Bₙ} to the values of the adjusted current temporary coefficients {Bₙ}; and entering the checking step; and;

if the output condition of the optimization coefficients is met, entering the output step; and

the output step includes:

selecting, from the first-type result to be selected, the current temporary coefficients {Bₙ} which have a maximum accuracy coverage range, as first-type optimization coefficients {bₙ}.

Preferably, in the calculation step, a set of current temporary coefficients {Bₙ} is randomly generated;

after the calculation step and before the checking step, the method further comprises: adjusting the current temporary coefficients {Bₙ} on the current basis of the current temporary coefficients {Bₙ} to obtain an adjusted temporary coefficients {Bₙ′}, herein values of the adjusted current temporary coefficients {Bₙ} are in the range from the floating upper limit to the floating lower limit preset for {Bₙ};

making previous temporary coefficients {Bₙ″} equal to the current temporary coefficients {Bₙ}; and

making the current temporary coefficients {Bₙ} equal to the adjusted temporary coefficients {Bₙ′};

the acquisition step further includes: making the previous temporary coefficients {Bₙ″} equal to the current temporary coefficients {Bₙ};

the initialization step further includes: setting an initial temperature A, setting a temperature decrease rate α, and setting a minimum temperature A₀;

in the checking step, if it is determined that the values, from 0 to the current discrete value, of the discrete variable Kₓ(i) in the finite difference scheme controlled by the current temporary coefficients {Bₙ} do not meet the first condition, then before the interference step, the method further includes:

determining whether a probability

$$exp [ \frac{\begin{matrix}E ( current temporary coefficient ) - \\ E ( previous temporary coefficient )\end{matrix}}{A} ]$$

of accepting a current solution is greater than a random number p, and if the probability

$$exp [ \frac{\begin{matrix}E ( current temporary coefficient ) - \\ E ( previous temporary coefficient )\end{matrix}}{A} ]$$

of accepting the current solution is not greater than the random number p, making the current temporary coefficients {Bₙ} equal to the previous temporary coefficients {Bₙ″}, herein, E(current temporary coefficient)−E(previous temporary coefficient) is a difference between a result of a Fourier transform, which uses the finite difference scheme controlled by the current temporary coefficients {Bₙ}, of a space partial derivative of the first-type equation when the discrete variable takes the current discrete value, and a result of a Fourier transform, which uses the finite difference scheme controlled by the current temporary coefficients {Bₙ″}, of a space partial derivative of the first-type equation when the discrete variable takes the current discrete value, and the random number p is a value between 0 and 1;

in the interference step, if the output condition of the optimization coefficients is met, and before the output step, the method further includes: determining whether A is greater than A₀; and if A is greater than A₀, making A=A*α, resetting the output condition of the optimization coefficients, and re-entering the interference step; and

if A is less than or equal to A₀, entering the output step.

Preferably, the calculation step further includes: setting the current discrete value to be in an unsolvable state;

the acquisition step further comprises: setting the current discrete value to be in a solvable state; determining whether the current discrete value is less than π; and if the current discrete value is less than π, increasing the current discrete value by one discrete interval to serve as the current discrete value, and re-entering the calculation step; and if the current discrete value is not less than π, entering the output step;

in the interference step, if the output condition of the optimization coefficients is met, and before the output step, the method further includes: if the A is less than or equal to A₀, determining whether the current discrete value is less than π; and if the current discrete value is less than π and the current discrete value is in a solvable state, increasing the current discrete value by one discrete interval to serve as the current discrete value, and re-entering the calculation step;

if the current discrete value is not less than π or the current discrete value is in an unsolvable state, entering the output step.

Preferably, in the case where the finite difference scheme is not a staggered-grid finite difference, the preset error limit T is 0.0001.

Preferably, in the case where the finite difference scheme is a staggered-grid finite difference, the preset error limit T is 0.00005.

Through the calculation step, the checking step, and the output step for acquiring the first-type optimization coefficients {bₙ} provided in the above invention, the following preferable first-type optimization coefficients can be obtained,

in the case where the first-type equation is a first order partial differential equation and the finite difference scheme is not a staggered-grid finite difference,

the first-type optimization coefficients bₙ for controlling a fourth-order finite difference scheme include: b₋₂, b₋₁, b₀, b₁, b₂, where, 0.0834≦b−2≦0.1985, and −0.1985≦b₂≦−0.0834;

the first-type optimization coefficients bₙ for controlling a sixth-order finite difference scheme include: b₋₃, b₋₂, b₋₁, b₀, b₁, b₂, b₃, where, −0.0357≦b₋₃≦−0.0167, 0.1501≦b₋₂≦0.2912, −0.2912≦b₂≦−0.1501 and 0.0167≦b₃≦0.0357;

the first-type optimization coefficients bₙ for controlling an eighth-order finite difference scheme include: b₋₄, b₋₃, b₋₂, b₋₁, b₀, b₁, b₂, b₃, b₄, where, 0.0036≦b₋₄≦0.0097, −0.0669≦b₋₃≦−0.0381, 0.2001≦b₋₂≦0.3698, −0.3698≦b₂≦−0.2001, 0.0381≦b₃≦0.0669 and −0.0097≦b₄≦−0.0036;

the first-type optimization coefficients bₙ for controlling a tenth-order finite difference scheme include: b₋₅, b₋₄, b₋₃, b₋₂, b₋₁, b₀, b₁, b₂, b₃, b₄, b₅, where, −0.0078≦b₋₅≦−0.0008, 0.01≦b₋₄≦0.0299, −0.1337≦b₋₃≦−0.0596, 0.2381≦b₋₂≦0.3325, −0.3325≦b₂≦−0.2381, 0.0596≦b₃≦0.1337, −0.0299≦b₄≦−0.01, and 0.0008≦b₅≦0.0078; and

the first-type optimization coefficients bₙ for controlling a twelfth-order finite difference scheme include: b₋₆, b₋₅, b₋₄, b₋₃, b₋₂, b₋₁, b₀, b₁, b₂, b₃, b₄, b₅ and b₆, where, 0.0001≦b₋₆≦0.0071, −0.0148≦b₋₅≦−0.0026, 0.0179≦b₋₄≦0.0588, −0.1527≦b₋₃≦−0.0794, 0.2679≦b₋₂≦0.3766, −0.3766≦b₂≦−0.2679, 0.0794≦b₃≦0.1527, −0.0588≦b₄≦−0.0179, 0.0026≦b₅≦0.0148, and −0.0071≦b₆≦−0.0001;

in the case where the first-type equation is a first order partial differential equation and the finite difference scheme is a staggered-grid finite difference,

the first-type optimization coefficients bₙ for controlling a fourth-order staggered-grid finite difference scheme include: b₋₁, b₁, b₂, where, 0.04167≦b₋₁≦0.0913 and 0.0913≦b₂≦−0.04167;

the first-type optimization coefficients bₙ for controlling a sixth-order staggered-grid finite difference scheme include: b₋₂, b₋₁, b₁, b₂, b₃, where, −0.0761≦b₋₂≦−0.0047, 0.0652≦b₋₁≦0.1820, −0.1820≦b₂≦−0.0652 and 0.0047≦b₃≦0.0761;

the first-type optimization coefficients bₙ for controlling an eighth-order staggered-grid finite difference scheme include: b₋₃, b₋₂, b₋₁, b₁, b₂, b₃, b₄, where, 0.0007≦b₋₃≦0.0034, −0.0188≦b₋₂≦−0.0096, 0.0798≦b₋₁≦0.1465, −0.1465≦b₂≦−0.0798, 0.0096≦b₃≦0.0188 and −0.0034≦b₄≦−0.0007;

the first-type optimization coefficients bₙ for controlling a tenth-order staggered-grid finite difference scheme include: b₋₄, b₋₃, b₋₂, b₋₁, b₁, b₂, b₃, b₄, b₅, where, −0.0088≦b₋₄≦−0.0002, 0.0018≦b₋₃≦0.0084, −0.0139≦b₋₂≦−0.0298, 0.0898≦b₋₁≦0.1969, −0.1969≦b₂≦−0.0898, 0.0139≦b₃≦0.0298, −0.0084≦b₄≦−0.0018 and 0.0002≦b₅≦0.0088; and

the first-type optimization coefficients bₙ for controlling a twelfth-order staggered-grid finite difference scheme include: b₋₅, b₋₄, b₋₃, b₋₂, b₋₁, b₁, b₂, b₃, b₄, b₅, b₆, where 0.0002≦b₋₅≦0.009, −0.0046≦b₋₄≦−0.0004, 0.0030≦b₋₃≦0.0979, −0.0599≦b₋₂≦−0.0175, 0.0970≦b₋₁≦0.1953, −0.1953≦b₂, −0.0970, 0.0175≦b₃≦0.0599, −0.0979≦b₄≦−0.0030, 0.0004≦b₅≦0.0046 and −0.009≦b₆≦−0.0002;

in the case where the first-type equation is a second-order partial differential equation and the finite difference scheme is not a staggered-grid finite difference,

the first-type optimization coefficients bₙ for controlling a fourth-order finite difference scheme include: b₋₂, b₋₁, b₀, b₁, b₂, where, −0.1648≦b₋₂≦−0.0834 and 0.1648≦b₂≦0.0834.

the first-type optimization coefficients bₙ for controlling a sixth-order finite difference scheme include: b₋₃, b₋₂, b₋₁, b₀, b₁, b₂, b₃, where, 0.0112≦b₋₃≦0.0373, −0.3018≦b₋₂≦−0.1510, −0.3018≦b₂≦−0.1510 and 0.0112≦b₃≦0.0373.

the optimization coefficients bₙ for controlling an eighth-order finite difference scheme include: b₋₄, b₋₃, b₋₂, b₋₁, b₀, b₁, b₂, b₃, b₄, where, −0.0086≦b₋₄≦−0.0018, 0.0254≦b₋₃≦0.0585, −0.3855≦b₋₂≦−0.2001, −0.3855≦b₂≦−0.2001, 0.0254≦b₃≦0.0585 and −0.0086≦b₄≦−0.0018;

the first-type optimization coefficients bₙ for controlling a tenth-order finite difference scheme include: b₋₅, b₋₄, b₋₃, b₋₂, b₋₁, b₀, b₁, b₂, b₃, b₄, b₅, where, 0.0004≦b₋₅≦0.0038, −0.0188≦b₋₄≦−0.0050, 0.0397≦b₋₃≦0.0837, −0.4826≦b₋₂≦−0.2384, −0.4826≦b₂≦−0.2384, 0.0397≦b₃≦0.0837, −0.0188≦b₄≦−0.0050 and 0.0004≦b₅≦0.0038; and

the first-type optimization coefficients bₙ for controlling a twelfth-order finite difference scheme include: b₋₆, b₋₅, b₋₄, b₋₃, b₋₂, b₋₁, b₀, b₁, b₂, b₃, b₄, b₅, b₆, where, −0.0037≦b₋₆≦−0.0007, 0.0011≦b₋₅≦0.0077, −0.0327≦b₋₄≦−0.0090, 0.0530≦b₋₃≦0.1128, −0.3927≦b₋₂≦−0.2679, −0.3927≦b₂≦−0.2679, 0.0530≦b₃≦0.1128, −0.0327≦b₄≦−0.0090, 0.0011≦b₅≦0.0077, and −0.0037≦b₆≦−0.0007.

According to the present invention, it is further provided a device for acquiring optimization coefficients, and the device includes:

an initialization unit, adapted to set a value of an error limit T, set an initial value of a current discrete value, and set an output condition of the optimization coefficients;

a calculation unit, adapted to randomly generate at least one set of current temporary coefficients {Bₙ}, wherein, Bₙ⁰≦Bₙ≦Bₙ¹, Bₙ¹ is a floating upper limit preset for Bₙ, Bₙ⁰ is a floating lower limit preset for Bₙ, and wherein the number of Bₙ in the current temporary coefficients {Bₙ} is decided by the order N that is adopted by a finite difference scheme;

a checking unit, adapted to determine whether values, from 0 to the current discrete value, of a discrete variable Kₓ(i) in the finite difference scheme controlled by the current temporary coefficients {Bₙ} meet a first condition;

herein, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of a space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;

if it is determined that the values, from 0 to the current discrete value, of the discrete variable Kₓ(i) in the finite difference scheme controlled by the current temporary coefficients {Bₙ} meet the first condition, send the current temporary coefficients {Bₙ} to an acquisition unit, and trigger the acquisition unit to operate;

if it is determined that the values, from 0 to the current discrete value, of the discrete variable Kₓ(i) in the finite difference scheme controlled by the current temporary coefficients {Bₙ} do not meet the first condition, send the current temporary coefficients {Bₙ} to an interference unit, and trigger the interference unit to operate;

an acquisition unit, adapted to: add the current temporary coefficients {Bₙ} into a first-type result to be selected; and

acquire an accuracy coverage range of the current temporary coefficients {Bₙ}, according to the determine whether the values, from 0 to the current discrete value, of the discrete variable Kₓ(i) in the finite difference scheme controlled by the current temporary coefficients {Bₙ} meet the first condition, herein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;

an interference unit, adapted to determine whether the output condition of the optimization coefficients is met; and

if the output condition of the optimization coefficients is not met, adjust the current temporary coefficients {Bₙ} on the current basis of the current temporary coefficients {Bₙ}, herein values of the adjusted current temporary coefficients {Bₙ} are in a range from the floating upper limit to the floating lower limit preset for {Bₙ}; update the current temporary coefficients {Bₙ} to the values of the adjusted current temporary coefficients {Bₙ}; and send the current temporary coefficients {Bₙ} to the checking unit, and trigger the checking unit to operate;

if the output condition of the optimization coefficients are met, trigger an output unit to operate; and

an output unit, adapted to select, from the first-type result to be selected, the current temporary coefficients {Bₙ} which have a maximum accuracy coverage range, as the first-type optimization coefficients {bₙ}.

According to the present invention, it is also provided a method for simulating seismic wave field based on optimization coefficients, and the method includes:

acquiring data of wave activated by a seismic source point, herein the data of wave activated by the seismic source point includes at least a wave velocity of the seismic source point, space coordinates of the seismic source point and time coordinates of the seismic source point;

acquiring a first-type equation involved in simulation for the seismic wave field activated by the seismic source point; and

simulating the seismic wave field activated by the seismic source point by applying a finite difference scheme controlled by the first-type optimization coefficients {bₙ} that are acquired by the above-described method for acquiring optimization coefficients, by using the data of wave activated by the seismic source point as input data of the first-type equation.

According to the present invention, it is further provided a device for simulating seismic wave field based on optimization coefficients, and the device includes:

a pre-processing unit, adapted to acquire data of wave activated by a seismic source point, herein the data of wave activated by the seismic source point includes at least a wave velocity of the seismic source point, space coordinates of the seismic source point and time coordinates of the seismic source point; and acquire a first-type equation involved in simulation for the seismic wave field activated by the seismic source point; and

a simulation unit, adapted to simulate the seismic wave field activated by the seismic source point by applying a finite difference scheme controlled by the first-type optimization coefficients {bₙ} that are acquired by the above-described method for acquiring optimization coefficients, by using the data of wave activated by the seismic source point as input data of the first-type equation.

It can be seen that, the present invention has advantageous effects as follows.

In the present invention, by determining whether the values, from 0 to the current discrete value, of the discrete variable Kₓ(i) in the finite difference scheme controlled by the current temporary coefficients {Bₙ} meet a first condition, the current temporary coefficients {Bₙ} meeting the condition are selected and are added into a result to be selected; by acquiring an accuracy coverage range of the current temporary coefficients {Bₙ}, founding a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition, and finally selecting the current temporary coefficients {Bₙ} having the maximum accuracy coverage range as the first-type optimization coefficients {bₙ}, thereby the first-type optimization coefficients {bₙ} having the maximum accuracy coverage range is found from several sets of randomly-generated optimization coefficients {bₙ} to serve as the optimization coefficients for controlling the finite difference scheme, which improves a frequency response range of a low-order finite difference scheme, and thus greatly improves the effect of seismic wave field simulation that is performed on a seismic source point by means of the finite difference scheme controlled by the optimization coefficients.

Secondly, when the current discrete value of discrete variable Kₓ(i) in the finite difference scheme controlled by the current temporary coefficients {Bₙ} does not meet a first condition, a probability of accepting the current solution is determined through a simulated annealing algorithm, discarding the set of current temporary coefficients {Bₙ} serving as local optimization coefficients, and re-calculating the current temporary coefficients {Bₙ}, thus increasing a possibility of finding the optimal first-type optimization coefficients {bₙ}.

Furthermore, the optimization coefficients {bₙ} acquired in the present invention differ from the fixed conventional coefficients of the existing finite difference scheme in that, the optimization coefficients {bₙ} acquired in the invention can meet different accuracy requirements in actual applications by adjusting the preset error limit T. A relatively larger preset error limit T would allow accuracy coverage range to be increased significantly, but the actual accuracy would be slightly lower than that in the case of a smaller preset error limit T. Therefore, the preset error limit T can be selected reasonably based on actual requirements in the specific applications.

Moreover, it is shown from experimental data that, under the premise of a comparable effect, in the seismic wave field simulation in which the first-type optimization coefficients {bₙ} acquired according to the present invention are used to control the finite difference scheme, memory consumption and calculation amount are reduced significantly compared with that in a conventional finite difference method.

### BRIEF DESCRIPTION OF THE DRAWINGS

FIG. 1 is a diagram illustrating an accuracy coverage range in the case of a finite difference scheme controlled by the existing conventional coefficients;

FIG. 2 is a diagram illustrating steps of a method for acquiring optimization coefficients;

FIG. 3 is a diagram illustrating steps of a preferred embodiment of the method for acquiring optimization coefficients;

FIG. 4 is a diagram illustrating a composition of an device for acquiring optimization coefficients;

FIG. 5 is a diagram illustrating steps of a method for simulating seismic wave field based on optimization coefficients;

FIG. 6 is a diagram illustrating a composition of a device for simulating seismic wave field based on optimization coefficients

FIG. 7-1 is a diagram illustrating an accuracy coverage range in the case of a finite difference scheme controlled by the existing conventional coefficient, according to a first experiment of the present invention;

FIG. 7-2 is a diagram illustrating an accuracy coverage range in the case of a finite difference scheme controlled by optimization coefficients, according to the first experiment of the present invention;

FIG. 8-1 is a diagram illustrating a simulation effect of seismic wave field simulation adopting a Marmousi model, according to a second experiment of the present invention;

FIG. 8-2 is a diagram illustrating accuracy-time curves respectively for the finite different scheme controlled by the existing conventional coefficients and for the finite different scheme controlled by the optimization coefficients of the present invention in the case of seismic wave field simulation adopting a Marmousi model;

FIG. 9-1 is a diagram illustrating a memory consumption amount and a calculation amount of seismic wave field simulation in which the existing conventional coefficients are used to control the finite difference scheme, according to a third experiment of the present invention; and

FIG. 9-2 is a diagram illustrating a memory consumption amount and a calculation amount of seismic wave field simulation in which the optimization coefficients of the present invention are used to control the finite difference scheme, according to the third experiment of the present invention.

### DETAILED DESCRIPTION OF THE INVENTION

To make the above object, features and advantages of the present invention to be more obvious and easy to be understood, in the following, the present invention will be illustrated in more detail in conjunction with the accompanying drawings and specific embodiments.

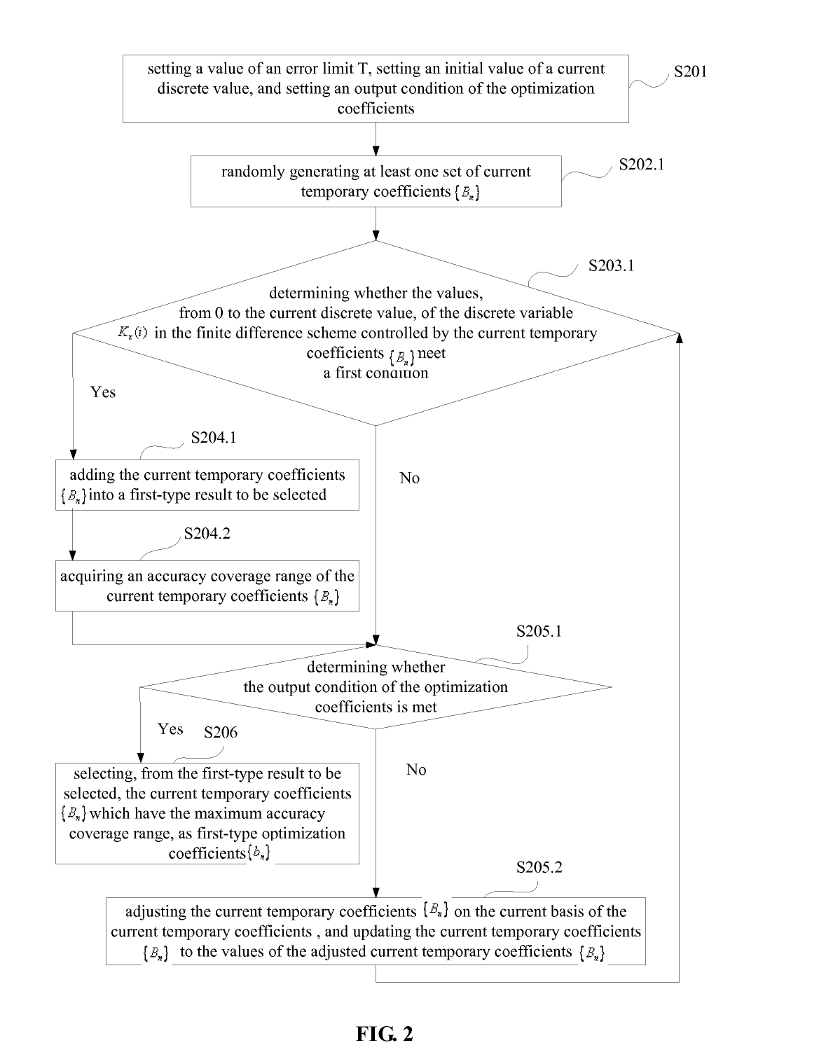

According to the present invention, it is provided a method for acquiring optimization coefficients, Referring to FIG. 2, the method includes: an initialization step, a calculation step, a checking step, an acquisition step, an interference step, and an output step, wherein,

S201, the initialization step includes:

setting a value of an error limit T;

setting an initial value of a current discrete value; and

setting an output condition of the optimization coefficients;

S202, the calculation step includes:

S202.1, randomly generating at least one set of current temporary coefficients {Bₙ}, herein, Bₙ⁰≦Bₙ≦Bₙ¹, Bₙ¹ is a floating upper limit preset for Bₙ, Bₙ⁰, is a floating lower limit preset for Bₙ, and herein the number of Bₙ in the current temporary coefficients {Bₙ} is decided by the order N that is adopted specifically by a finite difference scheme;

S203, the checking step includes:

S203.1, determining whether the values, from 0 to the current discrete value, of a discrete variable Kₓ(i) in the finite difference scheme controlled by the current temporary coefficients {Bₙ} meet a first condition;

Specifically, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of the space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;

if it is determined that the values, from 0 to the current discrete value, of the discrete variable Kₓ(i) in the finite difference scheme controlled by the current temporary coefficients {Bₙ} meet the first condition, entering the acquisition step;

if it is determined that it is not the case that the values, from 0 to the current discrete value, of the discrete variable Kₓ(i) in the finite difference scheme controlled by the current temporary coefficients {Bₙ} do not meet the first condition, entering the interference step;

It should be noted that, a wave equation is taken as an example of the discrete variable of the present invention, where the discrete variable is the discrete wave number, and its range is from 0 to π. A discrete interval between discrete values of the discrete variable should be preset as a relatively small interval, such as

$$\frac{π}{100} , \frac{π}{500}$$

$$and$$

$$\frac{π}{1000} ,$$

and the smaller the discrete interval is, the larger the calculation amount is. In one embodiment of the present invention, the discrete interval is

$$\frac{π}{100} ;$$

S204, the acquisition step includes:

S204.1, adding the current temporary coefficients {Bₙ} into a first-type result to be selected; and

S204.2, acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet a first condition, herein, a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;

S205, the interference step includes:

S205.1, determining whether the output condition of the optimization coefficients is met; and if the output condition of the optimization coefficients is met, entering the output step;

S205.2, if the output condition of the optimization coefficients is not met, adjusting the current temporary coefficients {Bₙ} on the current basis of the current temporary coefficients {Bₙ}, herein the values of the adjusted current temporary coefficients {Bₙ} are in the range from the floating upper limit to the floating lower limit preset for {Bₙ}, and updating the current temporary coefficients {Bₙ} to be the values of the adjusted current temporary coefficients {Bₙ}, and entering the checking step;

S206, the output step includes:

selecting, from the first-type result to be selected, the current temporary coefficients {Bₙ} which have the maximum accuracy coverage range, as first-type optimization coefficients {bₙ}.

It should be noted that, in the step of adjusting the current temporary coefficients {Bₙ} on the current basis of the current temporary coefficients {Bₙ}, the current temporary coefficients {Bₙ} can be adjusted according to requirements or experiences, for example, the current temporary coefficients {Bₙ} can be adjusted in the following three ways:

(1) randomly calculating the current temporary coefficients {Bₙ} in accordance with the method in the calculation step described above;

(2) presetting a fixed floating percentage, and floating the current temporary coefficients {Bₙ} on the current basis of the current temporary coefficients {Bₙ} by a certain percentage, such as 10%;

(3) presetting a floating percentage which changes with the number of times the current temporary coefficients {Bₙ} are adjusted, for example, the floating percentage is 20% for a first adjustment, the floating percentage is 19.5% for a second adjustment, the floating percentage is 19% for a third adjustment, the floating percentage is 18.5% for a fourth adjustment, and so on, so that the amount of the floating is reduced gradually to achieve an effect that a searching range converges gradually.

It can be seen from the above steps S201 to S206 that, by determining whether the values, from 0 to the current discrete value, of the discrete variable Kₓ(i) in the finite difference scheme controlled by the current temporary coefficients {Bₙ} meet a first condition, the current temporary coefficients {Bₙ} meeting the condition are selected and are added into a result to be selected; by acquiring an accuracy coverage range of the current temporary coefficients {Bₙ}, a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition, is found; and finally, the current temporary coefficients {Bₙ} having the maximum accuracy coverage range are selected as the first-type optimization coefficients {bₙ}, thereby the first-type optimization coefficients {bₙ} having the maximum accuracy coverage range is found from several sets of randomly-generated optimization coefficients {bₙ} to serve as the optimization coefficients for controlling the finite difference scheme, which improves a frequency response range of a low-order finite difference scheme, and thus greatly improves the effect of seismic wave field simulation that is performed on a seismic source point by means of the finite difference scheme controlled by the optimization coefficients.

In the following, the step S204.2, i.e. the acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet a first condition, will be illustrated in detail.

the maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition.

The accuracy coverage range of the current temporary coefficients {Bₙ} is acquired according to the prompt from the determining whether the values, from 0 to the current discrete value, of the discrete variable Kₓ(i) in the finite difference scheme controlled by the current temporary coefficients {Bₙ} meet the first condition. The accuracy coverage range of the current temporary coefficients {Bₙ} can be acquired by an assignment step and a screening step as follows:

the assignment step includes:

setting a current temporary discrete value to be equal to the current discrete value;

the screening step includes:

determining whether the values, from 0 to the current temporary discrete value, of the discrete variable Kₓ(i) in the finite difference scheme controlled by the current temporary coefficients {Bₙ} meet the first condition; and

if it is determined that the values, from 0 to the current temporary discrete value, of the discrete variable Kₓ(i) in the finite difference scheme controlled by the current temporary coefficients {Bₙ} meet the first condition, making the current temporary discrete value serve as a previous discrete value, increasing the current temporary discrete value by one discrete interval to serve as the current discrete value, and re-entering the screening step;

if it is determined that the values, from 0 to the current temporary discrete value, of the discrete variable Kₓ(i) in the finite difference scheme controlled by the current temporary coefficients {Bₙ} do not meet the first condition, making the previous discrete value serve as the accuracy coverage range of the current temporary coefficients {Bₙ}.

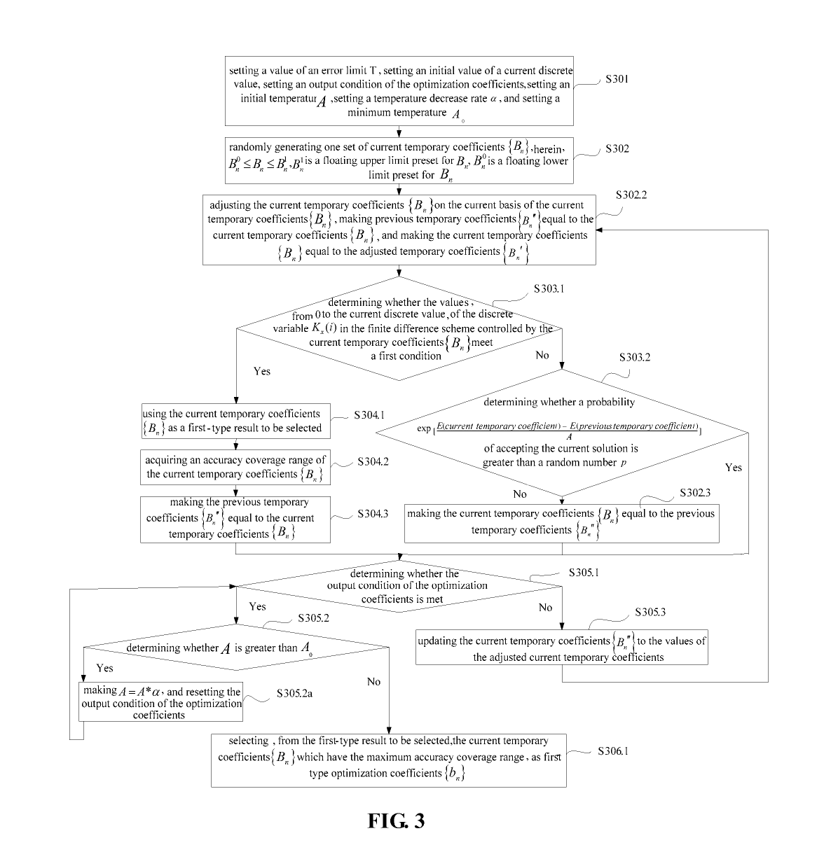

It should be noted that, in order to increase a possibility of searching for the optimal first-type optimization coefficients {bₙ} as far as possible, according to the present invention, it is also proposed to use a simulated annealing algorithm to further search for the first-type optimization coefficients {bₙ}. In order to illustrate the implementation process of the preferred embodiment more clearly, the initialization step, the calculation step, the checking step, the acquisition step, the interference step and the output step of the preferred embodiment for acquiring the first-type optimization coefficients {bₙ} will be wholly illustrated below in detail. Referring to FIG. 3:

S301, the initialization step includes:

setting a value of an error limit T;

setting an initial value of a current discrete value;

setting an output condition of the optimization coefficients;

setting an initial temperature A;

setting a temperature decrease rate α; and

setting a minimum temperature A₀;

S302, the calculation step includes:

S302.1, randomly generating one set of current temporary coefficients {Bₙ}, herein, Bₙ⁰≦Bₙ≦Bₙ¹, Bₙ¹ is a floating upper limit preset for Bₙ, Bₙ⁰ is a floating lower limit preset for Bₙ, and herein the number of Bₙ in the current temporary coefficients {Bₙ} is decided by the order N that is adopted specifically by a finite difference scheme;

S302.2, adjusting the current temporary coefficients {Bₙ} on the current basis of the current temporary coefficients {Bₙ} to obtain the adjusted temporary coefficients {Bₙ′}, herein the values of the adjusted current temporary coefficients {Bₙ} are in a range from the floating upper limit to the floating lower limit preset for {Bₙ};

making previous temporary coefficients {Bₙ″} equal to the current temporary coefficients {Bₙ}; and

making the current temporary coefficients {Bₙ} equal to the adjusted temporary coefficients {Bₙ′};

S303, the checking step includes:

S303.1, determining whether the values, from 0 to the current discrete value, of the discrete variable Kₓ(i) in the finite difference scheme controlled by the current temporary coefficients {Bₙ} meet a first condition, and if it is determined that the values, from 0 to the current discrete value, of the discrete variable Kₓ(i) in the finite difference scheme controlled by the current temporary coefficients {Bₙ} meet the first condition, entering the acquisition step;

where the first condition has the same meaning as that in the above other embodiments, which will not be described in detail herein;

S303.2, if it is determined that the values, from 0 to the current discrete value, of the discrete variable Kₓ(i) in the finite difference scheme controlled by the current temporary coefficients {Bₙ} do not meet the first condition, determining whether a probability

$$exp [ \frac{\begin{matrix}E ( current temporary coefficient ) - \\ E ( previous temporary coefficient )\end{matrix}}{A} ]$$

of accepting the current solution is greater than a random number p;

where,

E(current temporary coefficient)−E(previous temporary coefficient) is a difference between a result of a Fourier transform, which uses the finite difference scheme controlled by the current temporary coefficients {Bₙ}, of a space partial derivative of the first-type equation when the discrete variable takes the current discrete value, and a result of a Fourier transform, which uses the finite difference scheme controlled by the current temporary coefficients {Bₙ″}, of a space partial derivative of the first-type equation when the discrete variable takes the current discrete value, and the random number p is a value between 0 and 1;

S303.3, if the probability

$$exp [ \frac{\begin{matrix}E ( current temporary coefficient ) - \\ E ( previous temporary coefficient )\end{matrix}}{A} ]$$

of accepting the current solution is not greater than the random number p, making the current temporary coefficients {Bₙ} equal to the previous temporary coefficients {Bₙ″}; and

S303.4, entering the interference step;

S304, the acquisition step includes:

S304.1, adding the current temporary coefficients {Bₙ} into a first-type result to be selected;

S304.2, acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, herein, the maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition; and

S304.3, making previous temporary coefficients {Bₙ″} equal to the current temporary coefficients {Bₙ};

S305, the interference step includes:

S305.1, determining whether the output condition of the optimization coefficients is met;

S305.2, if the output condition of the optimization coefficients is met, determining whether A is greater than A₀, and if A is less than or equal to A₀, entering the output step;

S305.2a, if A is greater than A₀, making A=A*α, and resetting the output condition of the optimization coefficients, and re-entering the interference step; and

S305.3, if the output condition of the optimization coefficients is not met, adjusting the current temporary coefficients {Bₙ} on the current basis of the current temporary coefficients {Bₙ}, herein the values of the adjusted current temporary coefficients {Bₙ} are in a range from the floating upper limit to the floating lower limit preset for {Bₙ}, and updating the current temporary coefficients {Bₙ} to be the values of the adjusted current temporary coefficients {Bₙ}, and entering the checking step; and

S306, the output step includes:

S306.1, selecting, from the first-type result to be selected, the current temporary coefficients {Bₙ} which have the maximum accuracy coverage range, as first-type optimization coefficients {bₙ}.

Through a detailed illustration of the initialization step, the calculation step, the checking step, the acquisition step, the interference step, and the output step of the preferred embodiment for acquiring the first-type optimization coefficients {bₙ}, it can be seen that, the preferred embodiment differs from the previous embodiment for acquiring the first-type optimization coefficients {bₙ} in that:

(1) in the calculation step, one set of current temporary coefficients {Bₙ} is randomly generated;

(2) after the calculation step and before the checking step, the method further includes: adjusting the current temporary coefficients {Bₙ} on the current basis of the current temporary coefficients {Bₙ} to obtain the adjusted temporary coefficients {Bₙ′}, herein the values of the adjusted current temporary coefficients {Bₙ} are in the range from the floating upper limit to the floating lower limit preset for {Bₙ};

making previous temporary coefficients {Bₙ″} equal to the current temporary coefficients {Bₙ}; and

making the current temporary coefficients {Bₙ} equal to the adjusted temporary coefficients {Bₙ′};

(3) in the acquisition step, the method further includes: making the previous temporary coefficients {Bₙ″} equal to the current temporary coefficients {Bₙ};

(4) the initialization step further includes: setting an initial temperature A, setting a temperature decrease rate α, and setting a minimum temperature A₀;

(5) in the checking step, if it is determined that the values, from 0 to the current discrete value, of the discrete variable Kₓ(i) in the finite difference scheme controlled by the current temporary coefficients {Bₙ} meet the first condition, and before the interference step, the method further includes: determining whether a probability

$$exp [ \frac{\begin{matrix}E ( current temporary coefficient ) - \\ E ( previous temporary coefficient )\end{matrix}}{A} ]$$

of accepting the current solution is greater than a random number p, and if the probability

$$exp [ \frac{\begin{matrix}E ( current temporary coefficient ) - \\ E ( previous temporary coefficient )\end{matrix}}{A} ]$$

of accepting the current solution is not greater than the random number p, making the current temporary coefficients {Bₙ} equal to the previous temporary coefficients {Bₙ″}, herein, E(current temporary coefficient)−E(previous temporary coefficient) is a difference between a result of a Fourier transform, which uses the finite difference scheme controlled by the current temporary coefficients {Bₙ}, of a space partial derivative of the first-type equation when the discrete variable takes the current discrete value, and a result of a Fourier transform, which uses the finite difference scheme controlled by the current temporary coefficients {Bₙ″}, of a space partial derivative of the first-type equation when the discrete variable takes the current discrete value, and the random number p is a value between 0 and 1;

(6) in the interference step, if the output condition of the optimization coefficients is met, and before the output step, the method further includes: determining whether A is greater than A₀; and if A is greater than A₀, making A=A*α, resetting the output condition of the optimization coefficients, and re-entering the interference step; and

if A is less than or equal to A₀, entering the output step.

Moreover, in another embodiment of the present invention, it is proposed that, on the basis of the above preferred embodiment, the possibility of searching for the optimal first-type optimization coefficients {bₙ} can be further increased by the following steps.

the calculation step further includes: setting the current discrete value to be in an unsolvable state;

the acquisition step further includes: setting the current discrete value to be in a solvable state; determining whether the current discrete value is less than π; and if the current discrete value is less than π, increasing the current discrete value by one discrete interval to serve as the current discrete value, and re-entering the calculation step; and if the current discrete value is not less than π, entering the output step;

in the interference step, if the output condition of the optimization coefficients is met, and before the output step, the method further includes: if A is less than or equal to A₀, determining whether the current discrete value is less than π; and if the current discrete value is less than π and the current discrete value is in a solvable state, increasing the current discrete value by one discrete interval to serve as the current discrete value, and re-entering the calculation step;

if the current discrete value is not less than π or the current discrete value is in an unsolvable state, entering the output step.

It can be seen that, in the preferred embodiment, a circulation of searching for the first-type optimization coefficients {bₙ} is increased based on the simulated annealing algorithm cooling process, and whether to keep searching for the first-type optimization coefficients {bₙ} for the next discrete value is decided by determining whether there exists a solution in the current discrete values; and in the case where there exists a solution for the current discrete value, the probability of searching for the first-type optimization coefficients {bₙ} is increased by gradually increasing the current discrete value.

It should be noted that, for the output step, i.e. selecting, from the first-type result to be selected, the current temporary coefficients {Bₙ} which have the maximum accuracy coverage range, as the first-type optimization coefficients {bₙ}, if there exist several sets of current temporary coefficients {Bₙ} in the first-type result to be selected which have the maximum accuracy coverage range, in order to select one set of optimal current temporary coefficients {Bₙ}, the present invention further includes:

for each set of the current temporary coefficients {Bₙ} in the first-type result to be selected, obtaining an error of the Fourier transform in the finite difference scheme controlled by the current temporary coefficients {Bₙ} when the discrete variable Kₓ(i) takes individual discrete values in the accuracy coverage range, by calculating a difference between the result (jKₓ(i)^{C} of the Fourier transform of the space partial derivative of the first-type equation and the result of the Fourier transform in the finite difference scheme controlled by the current temporary coefficient {Bₙ} when the discrete variable Kₓ(i) takes individual discrete values in the accuracy coverage range.

On the basis of calculating the error of the Fourier transform, where the discrete variable Kₓ(i) takes each discrete value in the accuracy coverage range, of the finite difference scheme controlled by each current temporary coefficient {Bₙ}, in the output step, the selecting, from the first-type result to be selected, the current temporary coefficients {Bₙ} which have the maximum accuracy coverage range, as first-type optimization coefficients {bₙ} includes:

selecting, from the first-type result to be selected, the current temporary coefficients {Bₙ} which have the maximum accuracy coverage range and the minimum error sum, as the first-type optimization coefficients {bₙ}; and herein

the error sum of the current temporary coefficients {Bₙ} is obtained by calculating a sum of errors of Fourier transforms in the finite difference schemes controlled by individual sets of current temporary coefficient {Bₙ} in the first-type result to be selected when the discrete variable Kₓ(i) takes individual discrete values in the accuracy coverage range.

In the following, the output condition of the optimization coefficients in the preferred embodiment of the present invention will be illustrated in detail by way of the following two embodiments.

In one embodiment of the present invention, the output condition of the optimization coefficients may be that the number of times in which re-entering the interference step exceeds a preset interference times threshold. It can be seen that, the larger the interference times threshold is, the more the times in which current temporary coefficients {Bₙ} are recalculated while jumping out of the set of current temporary coefficients {Bₙ} as local optimization coefficients, and the further the possibility of searching for the optimal first-type optimization coefficients {bₙ} is increased. Therefore, the interference times threshold should be preset as a numerical value as large as possible. For example, the interference times threshold is preset as 60000.

In another embodiment of the present invention, the output condition of the optimization coefficients may be that the time for acquiring the first-type optimization coefficients {bₙ} exceeds a preset time threshold. It can also be seen that, the larger the time threshold is, the more the opportunity to recalculate current temporary coefficients {Bₙ} while jumping out of the set of current temporary coefficients {Bₙ} as local optimization coefficients, and the further the possibility of searching the optimal first-type optimization coefficients {bₙ} is increased. Therefore, the time threshold should be preset as a numerical value as large as possible, for example, the time threshold is preset as 7 days. Through the embodiment, an effect achieved by the seismic wave field simulation of the invention may be made consistent with a requirement at actual work time.

Considering that, in different application scenes implementing the present invention, there are different lowest requirements to the accuracy coverage range for the first-type optimization coefficients {bₙ} finally acquired, therefore, in a preferred embodiment of the present invention, the method further includes:

presetting an accuracy coverage range threshold; and

before the output step, the method further includes:

determining whether an accuracy coverage range of the set of the current temporary coefficients {Bₙ} in the first-type result to be selected that have the maximum accuracy coverage range is less than the preset accuracy coverage range threshold, and if the accuracy coverage range of the set of the current temporary coefficients {Bₙ} in the first-type result to be selected that have the maximum accuracy coverage range is less than the preset accuracy coverage range threshold, then the floating upper limit Bₙ¹ preset for Bₙ may be increased and/or the floating lower limit Bₙ⁰, preset for Bₙ may be reduced, and the method proceeds to the calculation step.

Of course, increasing the floating upper limit Bₙ¹ preset for Bₙ and/or reducing the floating lower limit Bₙ⁰, preset for Bₙ should be performed by referring the certain range of floating up and down of the existing conventional coefficient controlling a finite difference scheme, so as to improve the efficiency of acquiring the first-type optimization coefficients {bₙ}. Generally, the floating upper limit Bₙ¹ preset for Bₙ may be increased and/or the floating lower limit Bₙ⁰, preset for Bₙ may be reduced to 20%˜30% the original conventional coefficient for controlling the finite difference scheme.

For the step S202.1, in a preferred embodiment of the present invention, in the step of randomly generating current temporary coefficients {Bₙ}, a defining condition that defines the first-type optimization coefficients {bₙ} to meet a certain optimization condition is adopted to improve calculation velocity and accuracy. In the following, this preferred embodiment will be described in detail in three cases divided according to the types of the first-type equation and the finite difference scheme:

1. In the case where the first-type equation is a first order partial differential equation and the finite difference scheme is not a staggered-grid finite difference, the present invention further includes defining an optimization condition that the first-type optimization coefficients {bₙ} need to meet, specifically,

(1) defining that the current temporary coefficients {Bₙ} include first-type temporary coefficients {B₋ₘ}, a middle temporary coefficient B₀, and second-type temporary coefficients {Bₘ}, where m>0;

for example, a sixth-order finite difference scheme is adopted, and the current temporary coefficients {Bₙ} include B₋₃, B₋₂, B₋₁, B₀, B₁, B₂, B₃;

(2) defining that the first-type temporary coefficients {B₋ₘ} and the second-type temporary coefficients {Bₘ} are in odd symmetry relative to the middle temporary coefficient B₀;

(3) defining that in the first-type temporary coefficients {B₋ₘ} and the second-type temporary coefficients {Bₘ}, the production of any adjacent coefficients is negative;

according to the above optimization condition, a sixth-order finite difference scheme is taken as an example, and B₋₃=−B₃, B₋₂=−B₂, and B₋₁=−B₁;

(4) defining that the total sum of the current temporary coefficients {Bₙ} is 0;

according to the optimization condition, B₀=0; and

(5) defining that, in the first-type temporary coefficients {B₋ₘ} and the second-type temporary coefficients {Bₘ}, the more close to the middle temporary coefficient B₀, the greater the absolute value of the coefficient is.

2. in the case where the first-type equation is a second-order partial differential equation and the finite difference scheme is not a staggered-grid finite difference, the present invention further includes defining an optimization condition that the first-type optimization coefficients {bₙ} need to meet, specifically,

(1) defining that the current temporary coefficients {Bₙ} include first-type temporary coefficients {B₋ₘ}, a middle temporary coefficient B₀, and second-type temporary coefficients {Bₘ}, where m>0;

for example, a sixth-order finite difference scheme is adopted, and the current temporary coefficients {Bₙ} include B₋₃, B₋₂, B₋₁, B₀, B₁, B₂, B₃;

(2) defining that the first-type temporary coefficients {B₋ₘ} and the second-type temporary coefficients {Bₘ} are in even symmetry relative to the middle temporary coefficient B₀;

according to the optimization condition, a sixth-order finite difference scheme is taken as an example, and B₋₃=B₃, B₋₂=B₂, B₋₁=B₁;

(3) defining that in the first-type temporary coefficients {B₋ₘ} and the second-type temporary coefficients {Bₘ}, the production of any adjacent coefficients is negative;

(4) defining that the total sum of the current temporary coefficients {Bₙ} is 0; and

(5) defining that, in the first-type temporary coefficients {B₋ₘ} and the second-type temporary coefficients {Bₘ}, the more close to the middle temporary coefficient B₀, the greater the absolute value of the coefficient is.

For the above two cases 1 and 2, the calculation step, i.e. randomly generating at least one set of the current temporary coefficients {Bₙ} meeting the optimization condition may be implemented by the following steps:

allocating one first-type random number rₘ to each second-type temporary coefficient Bₘ to be solved, where 0≦rₘ≦1;

calculating values of the second-type temporary coefficients {Bₘ} according to Bₘ=Bₘ⁰+rₘ(Bₘ¹−Bₘ⁰), where Bₘ¹ is a floating upper limit preset for Bₘ, Bₘ⁰ is a floating lower limit preset for Bₘ; and

solving values of the first-type temporary coefficients {B₋ₘ} and a value of the middle temporary coefficient B₀ according to the optimization condition of the first-type optimization coefficients {bₙ} and the values of the second-type temporary coefficients {Bₘ}.

3. in the case where the first-type equation is a first order partial differential equation and the finite difference scheme is a staggered-grid finite difference, the present invention further includes defining an optimization condition that the first-type optimization coefficients {bₙ} need to meet, specifically,

(1) defining that the current temporary coefficients {Bₙ} include first-type temporary coefficients {B₋ₘ₊₁}, a middle temporary coefficient B₁, and second-type temporary coefficients {Bₘ}, where m>1;

for example, a sixth-order finite difference scheme is adopted, and the current temporary coefficients {Bₙ} include B₋₂, B₋₁, B₁, B₂, B₃;

(2) defining that the first-type temporary coefficients {B₋ₘ₊₁} and the second-type temporary coefficients {Bₘ} are in odd symmetry relative to the middle temporary coefficient B₁;

according to the optimization condition, a sixth-order finite difference scheme is taken as an example, and B₋₂=B₃, B₋₁=B₂;

(3) defining that in the first-type temporary coefficients {B₋ₘ₊₁} and the second-type temporary coefficients {Bₘ}, the production of any adjacent coefficients is negative; and

(4) defining that, in the first-type temporary coefficients {B₋ₘ₊₁} and the second-type temporary coefficients {Bₘ}, the more close to the middle temporary coefficient B₁, the greater the absolute value of the coefficient is.

For the above case 3, the calculation step, i.e. the randomly generating at least one set of the current temporary coefficients {Bₙ} meeting the optimization condition may be implemented by the following steps:

allocating one first-type random number rₘ to each second-type temporary coefficient Bₘ to be solved, where 0≦rₘ≦1;

calculating values of the second-type temporary coefficients {Bₘ} according to Bₘ=Bₘ⁰+rₘ(Bₘ¹−Bₘ⁰), where Bₘ¹ is a floating upper limit preset for Bₘ, and Bₘ⁰ is a floating lower limit preset for Bₘ; and

solving values of the first-type temporary coefficients {B₋ₘ₊₁} and a value of the middle temporary coefficient B₁ according to the optimization condition of the first-type optimization coefficients {bₙ} and the values of the second-type temporary coefficients {Bₘ}.

It should be noted that, in the calculation step, the preset floating upper limit Bₘ¹ and the preset floating lower limit Bₘ⁰ may be preset by floating up and down by a certain range with reference to the existing conventional coefficient for controlling a finite difference scheme.

In the following, the preset error limit T in the step S201 of the present invention will be illustrated in detail.

In an embodiment of the present invention, the finite difference scheme is not a staggered-grid finite difference, the preset error limit T may be 0.0001. In another embodiment of the present invention, the finite difference scheme is a staggered-grid finite difference, the preset error limit T may be 0.00005. Of course, a certain decimal in the vicinity of the value of the preset error limit suggested above may also be a selected object, and specifically, it can be set according to a requirement for implementing the present invention. But, it is crucial to select the error limit reasonably, a too small error limit will lead to a limited wave number range of accuracy coverage, and a too large error limit will bring a potential damage to an actual application although it may easily make the wave number range of accuracy coverage larger. For example, our experimental result indicates that: if an error limit in a range of 0.0003˜0.03 is selected, the whole wave number range may be covered, but the actual accuracy of the optimization coefficients obtained in the case where this error range is used as the constrain is lower. Therefore, the wave number coverage range cannot be extended purely by enlarging the error limit. Through numerical experiments and theoretical analysis, an error limit that ensures not only accuracy but also a larger wave number range of accuracy coverage is the value suggested above, that is, in the case where the finite difference scheme is not a staggered-grid finite difference, the preset error limit T suggested is 0.0001, and in the case where the finite difference scheme is a staggered-grid finite difference, the preset error limit T suggested is 0.00005.

In the following, the determining whether the values, from 0 to the current discrete value, of the discrete variable Kₓ(i) in the finite difference scheme controlled by the current temporary coefficients {Bₙ} meet a first condition in the step S203.1 of the present invention will also be illustrated by way of the following three embodiments of the present invention.

1. In the embodiment of the present invention where the first-type equation is a first order partial differential equation and the finite difference scheme is not a staggered-grid finite difference,

the finite difference discretization performed on the first order space partial derivative of a certain continuous function ƒ(x), actually refers to performing the following Taylor expansion at x=0:

$$\frac{\partial f}{\partial x} \approx \frac{1}{Δ} {\sum }_{n = - N / 2}^{N / 2} {b}_{n} cos ( n π ) {f}_{n}$$

therefore, the determining whether the values, from 0 to the current discrete value, of the discrete variable Kₓ(i) in the finite difference scheme controlled by the current temporary coefficients {Bₙ} meet a first condition, is performed by utilizing the following objective function:

$$E ( {K}_{x } ( i ) , T ) ≡ {max}_{0 \leq {k}_{x} ( i )} \vert - {K}_{x} ( i ) Δ - {\sum }_{n = - N / 2}^{N / 2} {B}_{n} sin ( - {K}_{x} ( i ) Δ n ) \vert \leq T ,$$

where Δ is a space grid spacing of data of wave activated by a seismic source point.

2. In the embodiment of the present invention where the first-type equation is a second-order partial differential equation and the finite difference scheme is not a staggered-grid finite difference,

the finite difference discretization performed on the second-order space partial derivative of a certain continuous function ƒ(x) actually refers to performing the following Taylor expansion at x=0:

$$\frac{{\partial }^{2} f}{\partial {x}^{2}} \approx \frac{1}{{Δ}^{2}} {\sum }_{n = - N / 2}^{N / 2} {b}_{n} cos ( n π ) {f}_{n}$$

Therefore, the determining whether the values, from 0 to the current discrete value, of the discrete variable Kₓ(i) in the finite difference scheme controlled by the current temporary coefficients {Bₙ} meet a first condition, is performed by utilizing the following objective function:

$$E ( {K}_{x } ( i ) , T ) ≡ {max}_{0 \leq {k}_{x} ( i )} \vert - {{K}_{x} ( i )}^{2} {Δ}^{2} - {\sum }_{n = - N / 2}^{N / 2} {B}_{n} cos ( n {K}_{x} ( i ) Δ ) \vert \leq T$$

3. In the embodiment of the present invention where the first-type equation is a first order partial differential equation and the finite difference scheme is a staggered-grid finite difference,

the finite difference discretization performed on the first order space partial derivative of a certain continuous function ƒ(x) actually refers to performing the following Taylor expansion at x=0:

$$\frac{\partial f}{\partial x} \approx \frac{1}{Δ} {\sum }_{n = - N / 2}^{N / 2} {b}_{n} sin [ ( 0.5 - n ) π ] {f}_{n}$$

Therefore, the determining whether the values, from 0 to the current discrete value, of the discrete variable Kₓ(i) in the finite difference scheme controlled by the current temporary coefficients {Bₙ} meet a first condition, is performed by utilizing the following objective function:

$$E ( {K}_{x } ( i ) , T ) ≡ {max}_{0 \leq {k}_{x} ( i )} \vert - {K}_{x} ( i ) Δ - {\sum }_{n = - N / 2}^{N / 2} {b}_{n} sin [ ( 0.5 - n ) {K}_{x} ( i ) Δ ] \vert \leq T .$$

By experimental data, the present invention shows that, through the above initialization step, the calculation step, the checking step, the acquisition step, the interference step, and the output step for acquiring first-type optimization coefficients {bₙ}, the first-type optimization coefficients {bₙ} having the following range can be obtained, which allow the effect of seismic wave field simulation to be greatly improved.

1. In the case where the first-type equation is a first order partial differential equation and the finite difference scheme is not a staggered-grid finite difference,

the first-type optimization coefficients bₙ for controlling a fourth-order finite difference scheme include: b₋₂, b₋₁, b₀, b₁, b₂, where, 0.0834≦b₋₂≦0.1985, and −0.1985≦b₂≦−0.0834;

the first-type optimization coefficients bₙ for controlling a sixth-order finite difference scheme include: b₋₃, b₋₂, b₋₁, b₀, b₁, b₂, b₃, where, −0.0357≦b₋₃≦−0.0167, 0.1501≦b₋₂≦0.2912, −0.2912≦b₂≦−0.1501 and 0.0167≦b₃≦0.0357;

the first-type optimization coefficients bₙ for controlling an eighth-order finite difference scheme include: b₋₄, b₋₃, b₋₂, b₋₁, b₀, b₁, b₂, b₃, b₄, where, 0.0036≦b₋₄≦0.0097, −0.0669≦b₋₃≦−0.0381, 0.2001≦b₋₂≦0.3698, −0.3698≦b₂≦−0.2001, 0.0381≦b₃≦0.0669 and −0.0097≦b₄≦−0.0036;

the first-type optimization coefficients bₙ for controlling a tenth-order finite difference scheme include: b₋₅, b₋₄, b₋₃, b₋₂, b₋₁, b₀, b₁, b₂, b₃, b₄, b₅, where, −0.0078≦b₋₅≦−0.0008, 0.01≦b₋₄≦0.0299, −0.1337≦b₋₃≦−0.0596, 0.2381≦b₋₂≦0.3325, −0.3325≦b₂≦−0.2381, 0.0596≦b₃≦0.1337, −0.0299≦b₄≦−0.01, and 0.0008≦b₅≦0.0078; and

the first-type optimization coefficients bₙ for controlling a twelfth-order finite difference scheme include: b₋₆, b₋₅, b₋₄, b₋₃, b₋₂, b₋₁, b₀, b₁, b₂, b₃, b₄, b₅ and b₆, where, 0.0001≦b₋₆≦0.0071, −0.0148≦b₋₅≦−0.0026, 0.0179≦b₋₄≦0.0588, −0.1527≦b₋₃≦−0.0794, 0.2679≦b₋₂≦0.3766, −0.3766≦b₂≦−0.2679, 0.0794≦b₃≦0.1527, −0.0588≦b₄≦−0.0179, 0.0026≦b₅≦0.0148, and −0.0071≦b₆≦−0.0001;

2. In the case where the first-type equation is a first order partial differential equation and the finite difference scheme is a staggered-grid finite difference,

the first-type optimization coefficients bₙ for controlling a fourth-order staggered-grid finite difference scheme include: b₋₁, b₁, b₂, where, 0.04167≦b₋₁≦0.0913 and 0.0913≦b₂≦−0.04167;

the first-type optimization coefficients bₙ for controlling a sixth-order staggered-grid finite difference scheme include: b₋₂, b₋₁, b₁, b₂, b₃, where, −0.0761≦b₋₂≦−0.0047, 0.0652≦b₋₁≦0.1820, −0.1820≦b₂≦−0.0652 and 0.0047≦b₃≦0.0761;

the first-type optimization coefficients bₙ for controlling an eighth-order staggered-grid finite difference scheme include: b₋₃, b₋₂, b₋₁, b₁, b₂, b₃, b₄, where, 0.0007≦b₋₃≦0.0034, −0.0188≦b₋₂≦−0.0096, 0.0798≦b₋₁≦0.1465, −0.1465≦b₂≦−0.0798, 0.0096≦b₃≦0.0188 and −0.0034≦b₄≦−0.0007;

the first-type optimization coefficients bₙ for controlling a tenth-order staggered-grid finite difference scheme include: b₋₄, b₋₃, b₋₂, b₋₁, b₁, b₂, b₃, b₄, b₅, where, −0.0088≦b₋₄≦−0.0002, 0.0018≦b₋₃≦0.0084, −0.0139≦b₋₂≦−0.0298, 0.0898≦b₋₁≦0.1969, −0.1969≦b₂≦−0.0898, 0.0139≦b₃≦0.0298, −0.0084≦b₄≦−0.0018 and 0.0002≦b₅≦0.0088; and

the first-type optimization coefficients bₙ for controlling a twelfth-order staggered-grid finite difference scheme include: b₋₅, b₋₄, b₋₃, b₋₂, b₋₁, b₁, b₂, b₃, b₄, b₅, b₆, where, 0.0002≦b₋₅≦0.009, −0.0046≦b₋₄≦−0.0004, 0.0030≦b₋₃≦0.0979, −0.0599≦b₋₂≦−0.0175, 0.0970≦b₋₁≦0.1953, −0.1953≦b₂≦−0.0970, 0.0175≦b₃≦0.0599, −0.0979≦b₄≦−0.0030, 0.0004≦b₅≦0.0046 and −0.009≦b₆≦−0.0002;

3. In the case where the first-type equation is a second-order partial differential equation and the finite difference scheme is not a staggered-grid finite difference,

the first-type optimization coefficients bₙ for controlling a fourth-order finite difference scheme include: b₋₂, b₋₁, b₀, b₁, b₂, where, −0.1648≦b₋₂≦−0.0834 and 0.1648≦b₂≦0.0834.

the first-type optimization coefficients bₙ for controlling a sixth-order finite difference scheme include: b₋₃, b₋₂, b₋₁, b₀, b₁, b₂, b₃, where, 0.0112≦b₋₃≦0.0373, −0.3018≦b₋₂≦−0.1510, −0.3018≦b₂≦−0.1510 and 0.0112≦b₃≦0.0373.

the optimization coefficients bₙ for controlling an eighth-order finite difference scheme include: b₋₄, b₋₃, b₋₂, b₋₁, b₀, b₁, b₂, b₃, b₄, where, −0.0086≦b₋₄≦−0.0018, 0.0254≦b₋₃≦0.0585, −0.3855≦b₋₂≦−0.2001, −0.3855≦b₂≦−0.2001, 0.0254≦b₃≦0.0585 and −0.0086≦b₄≦−0.0018;

the first-type optimization coefficients bₙ for controlling a tenth-order finite difference scheme include: b₋₅, b₋₄, b₋₃, b₋₂, b₋₁, b₀, b₁, b₂, b₃, b₄, b₅, where, 0.0004≦b₋₅≦0.0038, −0.0188≦b₋₄≦−0.0050, 0.0397≦b₋₃≦0.0837, −0.4826≦b₋₂≦−0.2384, −0.4826≦b₂≦−0.2384, 0.0397≦b₃≦0.0837, −0.0188≦b₄≦−0.0050 and 0.0004≦b₅≦0.0038; and

the first-type optimization coefficients bₙ for controlling a twelfth-order finite difference scheme include: b₋₆, b₋₅, b₋₄, b₋₃, b₋₂, b₋₁, b₀, b₁, b₂, b₃, b₄, b₅, b₆, where, −0.0037≦b₋₆≦−0.0007, 0.0011≦b₋₅≦0.0077, −0.0327≦b₋₄≦−0.0090, 0.0530≦b₋₃≦0.1128, −0.3927≦b₋₂≦−0.2679, −0.3927≦b₂≦−0.2679, 0.0530≦b₃≦0.1128, −0.0327≦b₄≦−0.0090, 0.0011≦b₅≦0.0077, and −0.0037≦b₆≦−0.0007.

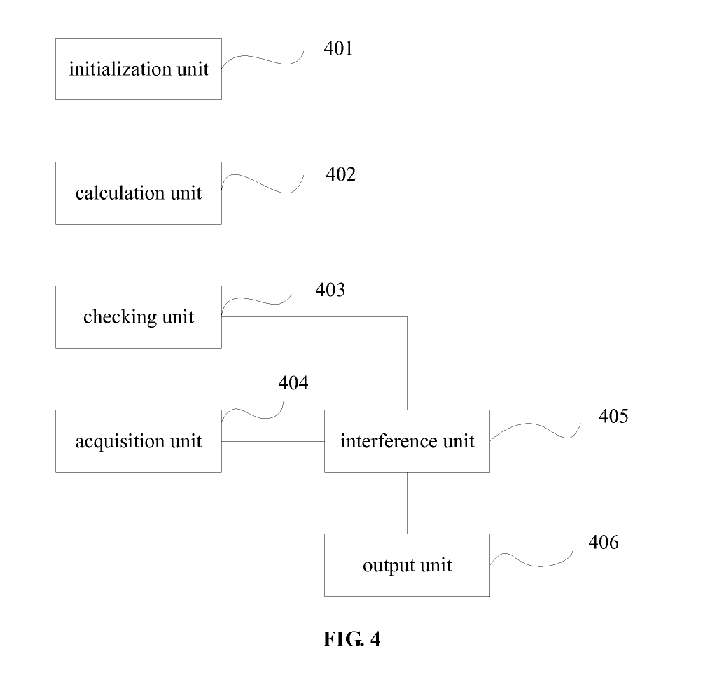

According to the present invention, it is further provided a device for acquiring optimization coefficients. Referring to FIG. 4, the device includes:

an initialization unit 401, adapted to set a value of an error limit T, set an initial value of a current discrete value, and set an output condition of the optimization coefficients;

a calculation unit 402, adapted to randomly generate at least one set of current temporary coefficients {Bₙ}, herein, Bₙ⁰≦Bₙ≦Bₙ¹, Bₙ¹ is a floating upper limit preset for Bₙ, Bₙ⁰ is a floating lower limit preset for Bₙ, and herein the number of Bₙ in the current temporary coefficients {Bₙ} is decided by the order N that is adopted specifically by a finite difference scheme;

a checking unit 403, adapted to:

determine whether the values, from 0 to the current discrete value, of a discrete variable Kₓ(i) in the finite difference scheme controlled by the current temporary coefficients {Bₙ} meet a first condition;

herein, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of a space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;

if it is determined that the values, from 0 to the current discrete value, of the discrete variable Kₓ(i) in the finite difference scheme controlled by the current temporary coefficients {Bₙ} meet the first condition, send the current temporary coefficients {Bₙ} to an acquisition unit 404, and trigger the acquisition unit 404 to operate;

if it is determined that the values, from 0 to the current discrete value, of the discrete variable Kₓ(i) in the finite difference scheme controlled by the current temporary coefficients {Bₙ} do not meet the first condition, send the current temporary coefficients {Bₙ} to an interference unit 405, and trigger the interference unit 405 to operate;

an acquisition unit 404, adapted to: add the current temporary coefficients {Bₙ} into a first-type result to be selected; and

acquire an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, herein the accuracy coverage range is a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;

an interference unit 405, adapted to determine whether the output condition of the optimization coefficients is met; and

if the output condition of the optimization coefficients is not met, adjust the current temporary coefficients {Bₙ} on the current basis of the current temporary coefficients {Bₙ}, herein the values of the adjusted current temporary coefficients {Bₙ} are in a range from the floating upper limit to the floating lower limit preset for {Bₙ}; update the current temporary coefficients {Bₙ} to the values of the adjusted current temporary coefficients {Bₙ}; and send the current temporary coefficients {Bₙ} to the checking unit 403, and trigger the checking unit 403 to operate;

if the output condition of the optimization coefficients is met, trigger an output unit 406 to operate;

an output unit 406, adapted to select, from the first-type result to be selected, the current temporary coefficients {Bₙ} which have the maximum accuracy coverage range, as the first-type optimization coefficients {bₙ}.

The present invention further provides a method for simulating seismic wave field based on optimization coefficients. Referring to FIG. 5, the method includes:

S501, acquiring data of wave activated by a seismic source point, herein the data of wave activated by the seismic source point includes at least a wave velocity of the seismic source point, space coordinates of the seismic source point and time coordinates of the seismic source point;

S502, acquiring a first-type equation involved in simulation for the seismic wave field activated by the seismic source point; and

S503, simulating the seismic wave field activated by the seismic source point by applying a finite difference scheme controlled by the first-type optimization coefficients {bₙ} that are acquired by the method for acquiring optimization coefficients according to any one of the above embodiments, by using the data of wave activated by the seismic source point as input data of the first-type equation.

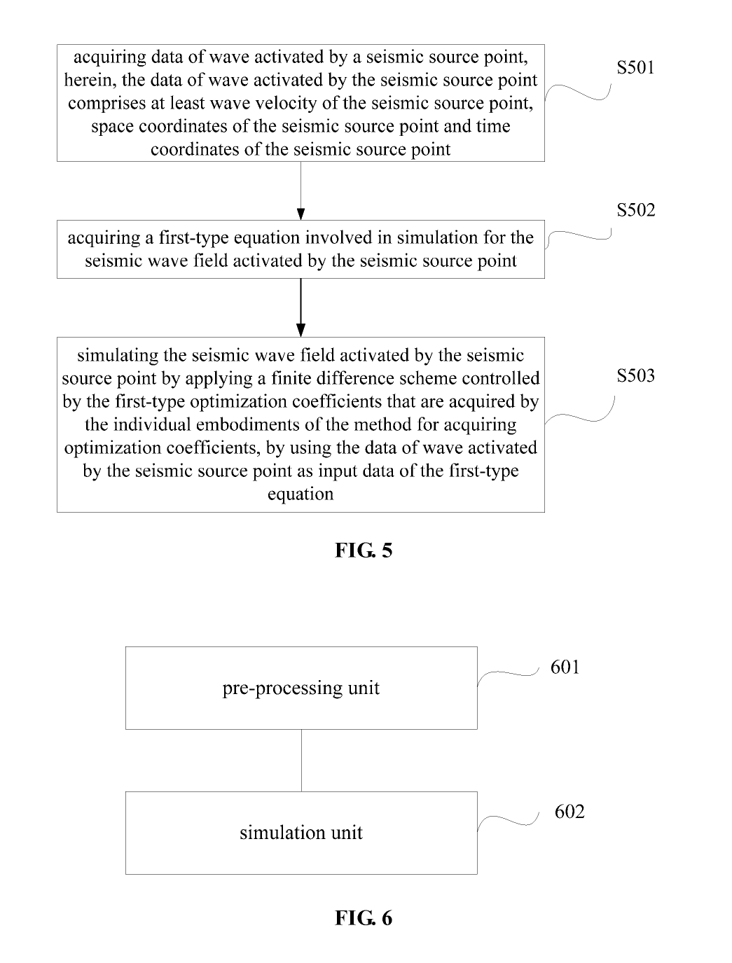

According to the present invention, it is further provided a device for simulating seismic wave field based on optimization coefficients. Referring to FIG. 6, the device includes:

a pre-processing unit 601, adapted to acquire data of wave activated by a seismic source point, herein, the data of wave activated by the seismic source point includes at least wave velocity of the seismic source point, space coordinates of the seismic source point and time coordinates of the seismic source point; and acquire a first-type equation involved in simulation for the seismic wave field activated by the seismic source point; and

a simulation unit 602, adapted to simulate the seismic wave field activated by the seismic source point by applying a finite difference scheme controlled by the first-type optimization coefficients {bₙ} that are acquired by the method for acquiring optimization coefficients according to any one of the above embodiments, by using the data of wave activated by the seismic source point as input data of the first-type equation.

In order to further illustrate the advantageous effect of the present invention, the effect of seismic wave field simulation using the finite difference scheme controlled by the optimization coefficients {bₙ} acquired in the present invention is compared with that using the finite difference scheme controlled by the existing conventional coefficient through the following experimental data illustration:

(First Experiment) from the View of an Accuracy Coverage Wave Number Range:

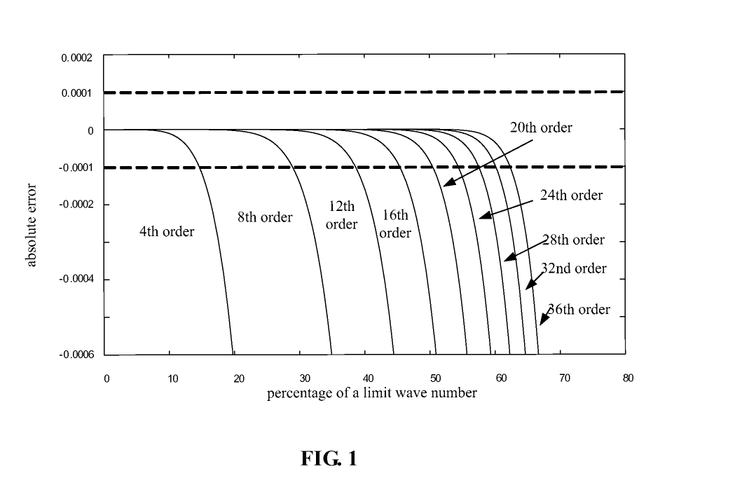

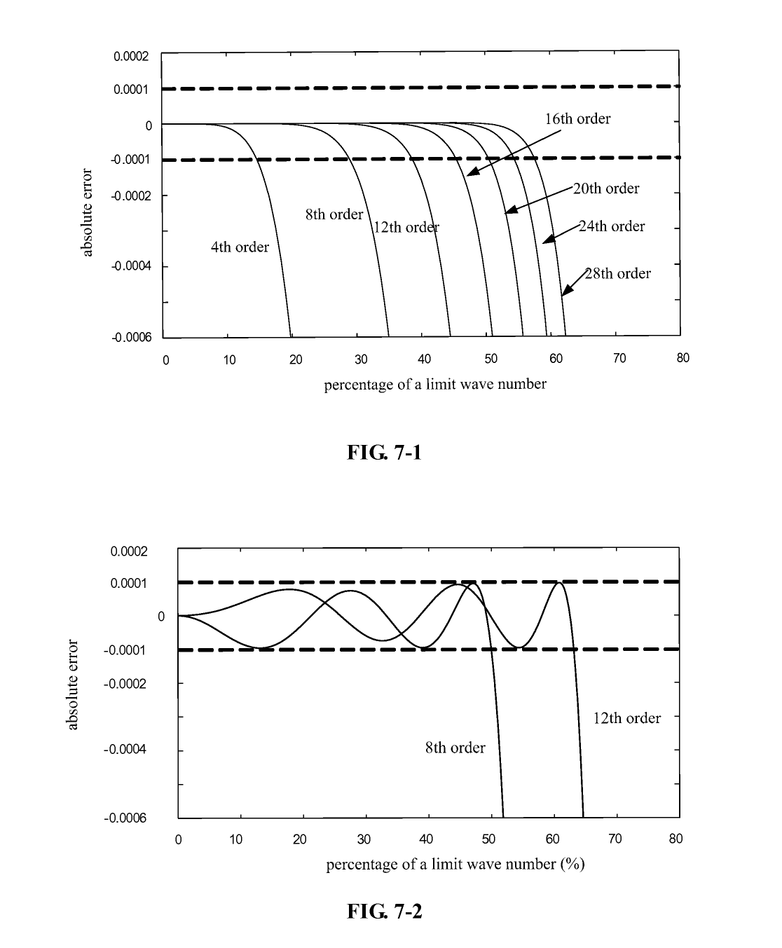

Referring to 7-1, in FIG. 7-1, the abscissa is a discrete variable wave number range, the ordinate is accuracy of a finite difference scheme, and solid curves in the coordinate system are accuracy-accuracy coverage wave number curves of a finite difference scheme controlled by the existing conventional coefficient in the case of a fourth-order Taylor expansion, an eighth-order Taylor expansion, a twelfth-order Taylor expansion, a sixteenth order Taylor expansion, a twentieth-order Taylor expansion, and a twenty-fourth-order Taylor expansion, and a twenty-eighth-order Taylor expansion, respectively.

Referring to 7-2, in FIG. 7-2, the abscissa is a discrete variable wave number range, the ordinate is accuracy of a finite difference scheme, and broken curves in the coordinate system are accuracy-accuracy coverage wave number curves of a finite difference scheme controlled by the optimization coefficients {bₙ} acquired in the invention in the case of a fourth-order Taylor expansion and an eighth-order Taylor expansion, respectively.

It can be seen from a comparison of FIG. 7-1 and FIG. 7-2 that, compared with the finite difference scheme controlled by the existing conventional coefficients, for the same order Taylor expansion, the finite difference scheme controlled by the optimization coefficients {bₙ} acquired in the invention has a larger accuracy coverage range. For example, the accuracy coverage range of the eighth-order Taylor expansion in the finite difference scheme controlled by the optimization coefficients {bₙ} is substantially consistent with the accuracy coverage range of the twelfth-order Taylor expansion in the finite difference scheme controlled by the existing conventional coefficients; and the accuracy coverage range of the twelfth-order Taylor expansion in the finite difference scheme controlled by the optimization coefficients {bₙ} is substantially consistent with the accuracy coverage range of the twenty-fourth-order Taylor expansion in the finite difference scheme controlled by the existing conventional coefficients.

(Second Experiment) from the View of the Change of the Accuracy of Seismic Wave Field Simulation Over Time:

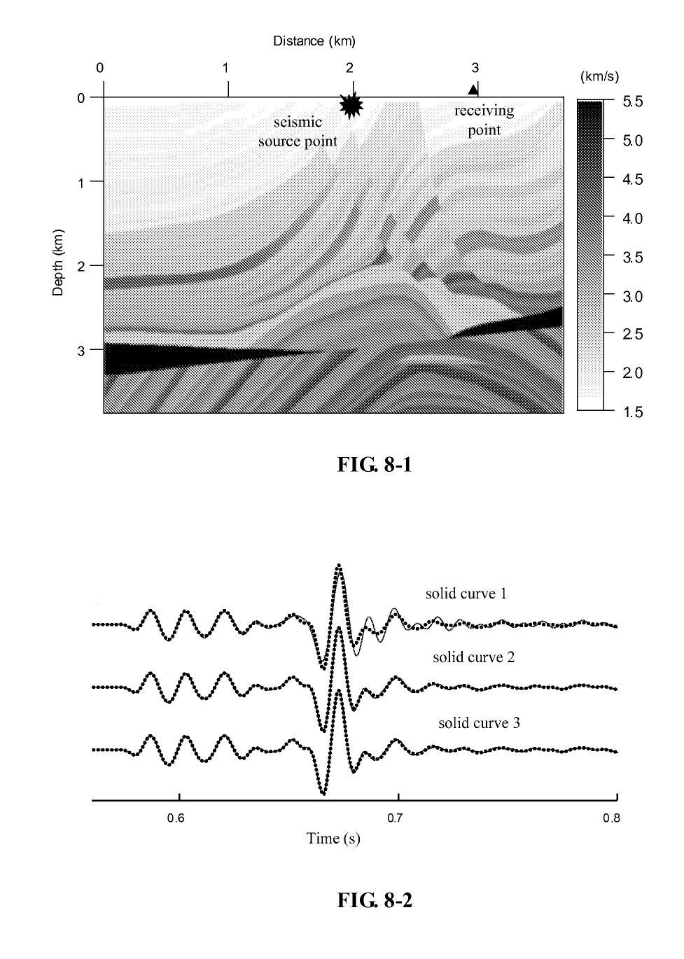

Referring to FIG. 8-1, the seismic wave field simulation adopts a Marmousi model to perform a seismic wave field simulation, and for ease of comparison, grids of the Marmousi model are uniformly set as uniform grids, a space grid spacing Δ=5 m, the number of the grids of the Marmousi model are 737×751, a dominant frequency of a Ricker wavelet is 50 Hz, the seismic source point is located at a position with a horizontal distance of 2000 m horizontally and a depth of 20 m, and a receiving point is located at a position with a horizontal distance of 3000 m and a depth of 5 m;

Referring to FIG. 8-2, in FIG. 8-2:

the abscissa indicates a time range;

the ordinate indicates a seismic wave field simulation accuracy range;

a broken curve is an accuracy change curve of seismic wave field simulation in the case of a thirty-sixth-order Taylor expansion in a finite difference scheme controlled by a conventional coefficients;

a solid curve 1 is an accuracy change curve of seismic wave field simulation in the case of a twelfth-order Taylor expansion in a finite difference scheme controlled by the existing conventional coefficients;

a solid curve 2 is an accuracy change curve of seismic wave field simulation in the case of a twenty-fourth-order Taylor expansion in a finite difference scheme controlled by the existing conventional coefficients; and

a solid curve 3 is an accuracy change curve of seismic wave field simulation in the case of a twelfth-order Taylor expansion in a finite difference scheme controlled by the optimization coefficients {bₙ} acquired in the invention.

It should be noted that, FIG. 2 is a common means for evaluating performance of a seismic wave field simulation method, the accuracy curve of seismic wave field simulation in the case of a thirty-sixth-order Taylor expansion in a finite difference scheme controlled by the existing conventional coefficients, i.e. the broken curve in FIG. 8-2, is used as an ideal value reference, and the more the solid curve is consistent with the broken curve, the higher the accuracy is.

It can be seen from FIG. 8-2 that, the accuracy change curve of seismic wave field simulation in the case of a twelfth-order Taylor expansion in a finite difference scheme controlled by the optimization coefficients {bₙ} acquired in the invention is much better than the accuracy change curve of seismic wave field simulation in the case of a twelfth-order Taylor expansion in a finite difference scheme controlled by the existing conventional coefficients, and is comparable with the accuracy change curve of seismic wave field simulation that in the case of a twenty-fourth-order Taylor expansion in a finite difference scheme controlled by the existing conventional coefficients.

(Third Experiment) from the View of a Memory Consumption Amount and a Calculation Amount

In the experiment, as a premise of comparison, for a given velocity model of seismic wave field simulation, the size of the model is fixed, but the grid dividing spacing and the number of the grids can be changed, and it is ensured that, no numerical dispersion occurs on the model during its division.

In the column chart 9-1, the abscissa is the number of orders of a Taylor expansion in a finite difference scheme, the ordinate is a scale of a memory amount or a calculation amount, a solid column 1 is a memory consumption amount of seismic wave field simulation adopting the existing conventional coefficient to control the finite difference scheme, and a broken column 1 is a calculation amount of seismic wave field simulation adopting the existing conventional coefficient to control the finite difference scheme.

In the column chart 9-2, the abscissa is the number of orders of a Taylor expansion in a finite difference scheme, the ordinate is a scale of a memory amount or a calculation amount, a solid column 2 is a memory consumption amount of seismic wave field simulation adopting the optimization coefficients {bₙ} acquired in the invention to control the finite difference scheme, and a broken column 2 is a calculation amount of seismic wave field simulation adopting the optimization coefficients {bₙ} acquired in the invention to control the finite difference scheme.

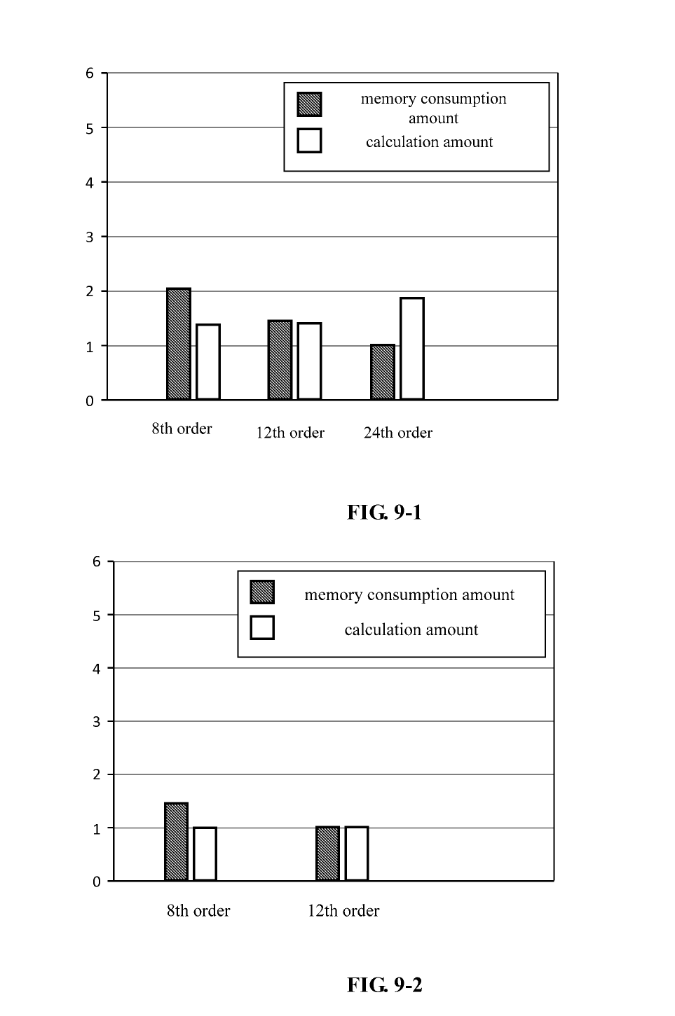

It can be seen from a comparison of FIG. 9-1 and FIG. 9-2 that,

compared with the seismic wave field simulation in the case of a twelfth-order Taylor expansion in a finite difference scheme controlled by the existing conventional coefficients, the seismic wave field simulation in the case of an eighth-order Taylor expansion in a finite difference scheme controlled by the optimization coefficients {bₙ} acquired in the invention has a comparable memory consumption amount and a smaller calculation amount; and

compared with the seismic wave field simulation that in the case of a twenty-fourth-order Taylor expansion in a finite difference scheme controlled by the existing conventional coefficients, the seismic wave field simulation in the case of a twelfth-order Taylor expansion in a finite difference scheme controlled by the optimization coefficients {bₙ} acquired in the invention has a comparable memory consumption amount and a smaller calculation amount.

It should be noted that, terminologies such as “a first”, “a second”, “the first”, “the second” herein are just used in distinguishing one entity or operation from another entity or operation, and are not bound to require or imply any kind of the actual relationship or sequence existing between these entities and operations. Moreover, terminologies “include”, “comprise” or any other variations are intended to cover all nonexclusive containing, such that a process, method, article, or equipment including a series of elements includes not only the listed elements, but also other elements not listed specifically, or includes the inherent elements thereof. Without more restrictions, the element defined by the sentence “including/comprising a . . . ” does not exclude that the process, method, article, or equipment includes more than one of that element.

The above embodiments are only preferred embodiments of the invention, and are not used to limit the scope of protection of the invention. Any change, equivalent alternation, modification and the like made within the spirit and principle of the present invention fall within the scope of protection of the present invention.

1. A method for acquiring optimization coefficients, comprising: an initialization step, a calculation step, a checking step, an acquisition step, an interference step, and an output step, wherein,
the initialization step comprises:
setting a value of an error limit T;
setting an initial value of a current discrete value; and
setting an output condition of the optimization coefficients;
the calculation step comprises:
randomly generating at least one set of current temporary coefficients {Bₙ}, wherein, Bₙ⁰≦Bₙ≦Bₙ¹, Bₙ¹ is a floating upper limit preset for Bₙ, Bₙ⁰ is a floating lower limit preset for Bₙ, and wherein the number of Bₙ in the current temporary coefficients {Bₙ} is decided by the order N that is adopted by a finite difference scheme;
the checking step comprises:
determining whether values, from 0 to the current discrete value, of a discrete variable Kₓ(i) in the finite difference scheme controlled by the current temporary coefficients {Bₙ} meet a first condition;
wherein, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of a space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;
if it is determined that the values, from 0 to the current discrete value, of the discrete variable Kₓ(i) in the finite difference scheme controlled by the current temporary coefficients {Bₙ} meet the first condition, entering the acquisition step;
if it is determined that the values, from 0 to the current discrete value, of the discrete variable Kₓ(i) in the finite difference scheme controlled by the current temporary coefficients {Bₙ} do not meet the first condition, entering the interference step;
the acquisition step comprises:
adding the current temporary coefficients {Bₙ} into a first-type result to be selected; and
acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, wherein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;
the interference step comprises:
determining whether the output condition of the optimization coefficients is met; and
in the case that the output condition of the optimization coefficients is not met, adjusting the current temporary coefficients {Bₙ} on a current basis of the current temporary coefficients {Bₙ}, wherein the values of the adjusted current temporary coefficients {Bₙ} are in a range from the floating upper limit to the floating lower limit preset for {Bₙ}; and updating the current temporary coefficients {Bₙ} to the values of the adjusted current temporary coefficients {Bₙ}, and entering the checking step; and
in the case that the output condition of the optimization coefficients is met, entering the output step; and
the output step comprises:
selecting, from the first-type result to be selected, the current temporary coefficients {Bₙ} which have a maximum accuracy coverage range, as first-type optimization coefficients {bₙ}.

2. The method according to claim 1, wherein,
in the calculation step, a set of current temporary coefficients {Bₙ} is randomly generated;
after the calculation step and before the checking step, the method further comprises: adjusting the current temporary coefficients {Bₙ} on the current basis of the current temporary coefficients {Bₙ} to obtain an adjusted temporary coefficients {Bₙ′}, wherein values of the adjusted current temporary coefficients {Bₙ} are in a range from the floating upper limit to the floating lower limit preset for {Bₙ};
making previous temporary coefficients {Bₙ″} equal to the current temporary coefficients {Bₙ}; and
making the current temporary coefficients {Bₙ} equal to the adjusted temporary coefficients {Bₙ′};
the acquisition step further comprises: making the previous temporary coefficients {Bₙ″} equal to the current temporary coefficients {Bₙ};
the initialization step further comprises: setting an initial temperature A, setting a temperature decrease rate α, and setting a minimum temperature A₀;
in the checking step, if it is determined that the values, from 0 to the current discrete value, of the discrete variable Kₓ(i) in the finite difference scheme controlled by the current temporary coefficients {Bₙ} do not meet the first condition, and before the interference step, the method further comprises:
determining whether a probability
$$exp [ \frac{\begin{matrix}E ( current temporary coefficient ) - \\ E ( previous temporary coefficient )\end{matrix}}{A} ]$$
of accepting a current solution is greater than a random number p, and if the probability
$$exp [ \frac{\begin{matrix}E ( current temporary coefficient ) - \\ E ( previous temporary coefficient )\end{matrix}}{A} ]$$
of accepting the current solution is not greater than the random number p, making the current temporary coefficients {Bₙ} equal to the previous temporary coefficients {Bₙ″}, wherein, E(current temporary coefficient)−E(previous temporary coefficient) is a difference between a result of a Fourier transform, which uses the finite difference scheme controlled by the current temporary coefficients {Bₙ}, of a space partial derivative of the first-type equation when the discrete variable takes the current discrete value, and a result of a Fourier transform, which uses the finite difference scheme controlled by the current temporary coefficients {Bₙ″}, of a space partial derivative of the first-type equation when the discrete variable takes the current discrete value, and the random number p is a value between 0 and 1;
in the interference step, if the output condition of the optimization coefficients is met, and before the output step, the method further comprises: determining whether A is greater than A₀; and
in the case that A is greater than A₀, making A=A*α, resetting the output condition of the optimization coefficients, and re-entering the interference step; and
in the case that A is less than or equal to A₀, entering the output step.

3. The method according to claim 2, wherein,
the calculation step further comprises: setting the current discrete value to be in an unsolvable state;
the acquisition step further comprises: setting the current discrete value to be in a solvable state; determining whether the current discrete value is less than π; and if the current discrete value is less than π, increasing the current discrete value by one discrete interval to serve as the current discrete value, and re-entering the calculation step; and if the current discrete value is not less than π, entering the output step;
in the interference step, if the output condition of the optimization coefficients is met, and before the output step, the method further comprises:
in the case that A is less than or equal to A₀, determining whether the current discrete value is less than π; and if the current discrete value is less than π and the current discrete value is in a solvable state, increasing the current discrete value by one discrete interval to serve as the current discrete value, and entering the calculation step; and
in the case that the current discrete value is not less than π or the current discrete value is in an unsolvable state, entering the output step.

4. The method according to claim 1, further comprising:
for each set of the current temporary coefficients {Bₙ} in the first-type result to be selected, obtaining an error of the Fourier transform in the finite difference scheme controlled by the current temporary coefficients {Bₙ} in the case that the discrete variable Kₓ(i) takes individual discrete values in the accuracy coverage range, by calculating a difference between the result (jKₓ (i))^{C} of the Fourier transform of the space partial derivative of the first-type equation and the result of the Fourier transform in the finite difference scheme controlled by the current temporary coefficient {Bₙ} in the case that the discrete variable Kₓ(i) takes individual discrete values in the accuracy coverage range.

5. The method according to claim 4, wherein, the selecting, from the first-type result to be selected, the current temporary coefficients {Bₙ} which have a maximum accuracy coverage range, as first-type optimization coefficients {bₙ} comprises: selecting, from the first-type result to be selected, the current temporary coefficients {Bₙ} which have the maximum accuracy coverage range and a minimum error sum, as the first-type optimization coefficients {bₙ}, and wherein,
the error sum of the current temporary coefficients {Bₙ} is obtained by calculating a sum of errors of Fourier transforms in the finite difference schemes controlled by individual sets of current temporary coefficient {Bₙ} in the first-type result to be selected in the case that the discrete variable Kₓ(i) takes individual discrete values in the accuracy coverage range.

6. The method according to claim 1, further comprising:
in the case where the first-type equation is a first-order partial differential equation and the finite difference scheme is not a staggered-grid finite difference, defining the first-type optimization coefficients {bₙ} to meet an optimization condition, wherein the optimization condition comprises:
defining that the current temporary coefficients {Bₙ} comprise first-type temporary coefficients {B₋ₘ}, a middle temporary coefficient B₀, and second-type of temporary coefficients {Bₘ}, where m>0;
defining that the first-type temporary coefficients {B₋ₘ} and the second-type of temporary coefficients {Bₘ} are in odd symmetry relative to the middle temporary coefficient B₀;
defining that in the first-type temporary coefficients {B₋ₘ} and the second-type temporary coefficients {Bₘ}, the production of any adjacent coefficients is negative;
defining that the total sum of the current temporary coefficients {Bₙ} is 0; and
defining that, in the first-type temporary coefficients {B₋ₘ} and the second-type temporary coefficients {Bₘ}, the more close to the middle temporary coefficient B₀, the greater the absolute value of the coefficient is;
in the case where the first-type equation is a second-order partial differential equation and the finite difference scheme is not a staggered-grid finite difference, defining the first-type optimization coefficients {bₙ} to meet an optimization condition, wherein the optimization condition comprises:
defining that the current temporary coefficients {Bₙ} comprise first-type temporary coefficients {B₋ₘ}, a middle temporary coefficient B₀, and second-type temporary coefficients {Bₘ}, where m>0;
defining that the first-type temporary coefficients {B₋ₘ} and the second-type temporary coefficients {Bₘ} are in even symmetry relative to the middle temporary coefficient B₀;
defining that in the first-type temporary coefficients {B₋ₘ} and the second-type temporary coefficients {Bₘ}, the production of any adjacent coefficients is negative;
defining that the total sum of the current temporary coefficients {Bₙ} is 0; and
defining that, in the first-type temporary coefficients {B₋ₘ} and the second-type temporary coefficients {Bₘ}, the more close to the middle temporary coefficient B₀, the greater the absolute value of the coefficient is;
in the case where the first-type equation is a first-order partial differential equation and the finite difference scheme is a staggered-grid finite difference, defining the first-type optimization coefficients {bₙ} to meet an optimization condition, wherein the optimization condition comprises:
defining that the current temporary coefficients {Bₙ} comprise first-type temporary coefficients {B₋ₘ₊₁}, a middle temporary coefficient B₁, and second-type temporary coefficients {Bₘ}, where m>1;
defining that the first-type temporary coefficients {B₋ₘ₊₁} and the second-type temporary coefficients {Bₘ} are in odd symmetry relative to the middle temporary coefficient B₁;
defining that in the first-type temporary coefficients {B₋ₘ₊₁} and the second-type temporary coefficients {Bₘ}, the production of any adjacent coefficients is negative; and
defining that, in the first-type temporary coefficients {B₋ₘ₊₁} and the second-type temporary coefficients {Bₘ}, the more close to the middle temporary coefficient B₁, the greater the absolute value of the coefficient.

7. The method according to claim 6, wherein
in the case where the first-type equation is a first-order or second-order partial differential equation and the finite difference scheme is not a staggered-grid finite difference, the calculation step of randomly generating at least one set of current temporary coefficients {Bₙ} comprises:
allocating one first-type random number rₘ to each second-type temporary coefficient Bₘ to be solved, where 0≦rₘ≦1;
calculating values of the second-type temporary coefficients {Bₘ} according to Bₘ=Bₘ⁰+rₘ(Bₘ¹−Bₘ⁰), where Bₘ¹ is a floating upper limit preset for Bₘ, and Bₘ⁰ is a floating lower limit preset for Bₘ; and
obtaining values of the first-type temporary coefficients {B₋ₘ} and a value of the middle temporary coefficient B₀ according to the optimization condition of the first-type optimization coefficients {bₙ} and the values of the second-type temporary coefficients {Bₘ};
in the case where the first-type equation is a first-order partial differential equation and the finite difference scheme is a staggered-grid finite difference, the calculation step of randomly generating at least one set of current temporary coefficients {Bₙ} comprises:
allocating one first-type random number rₘ to each second-type temporary coefficient Bₘ to be solved, where 0≦rₘ≦1;
calculating values of the second-type temporary coefficients {Bₘ} according to Bₘ=Bₘ⁰+rₘ(Bₘ¹−Bₘ⁰), where Bₘ¹ is a floating upper limit preset for Bₘ, and Bₘ⁰ is a floating lower limit preset for Bₘ; and
obtaining values of the first-type temporary coefficients {B₋ₘ₊₁} and a value of the middle temporary coefficient B₁ according to the optimization condition of the first-type optimization coefficients {bₙ} and the values of the second-type temporary coefficients {Bₘ}.

8. The method according to claim 1, wherein the output condition of the optimization coefficients is that the number of times of re-entering the interference step exceeds a preset interference times threshold.

9. The method according to claim 1, wherein in the case where the finite difference scheme is not a staggered-grid finite difference, the preset error limit T is 0.0001.

10. The method according to claim 1, wherein in the case where the finite difference scheme is a staggered-grid finite difference, the preset error limit T is 0.00005.

11. The method according to claim 1, wherein
in the case where the first-type equation is a first-order partial differential equation and the finite difference scheme is not a staggered-grid finite difference, the determining whether the values, from 0 to the current discrete value, of the discrete variable Kₓ(i) in the finite difference scheme controlled by the current temporary coefficients {Bₙ} meet the first condition, is performed by utilizing the following objective function:
$$E ( {K}_{x } ( i ) , T ) ≡ {max}_{0 \leq {k}_{x} ( i )} \vert - {K}_{x} ( i ) Δ - {\sum }_{n = - N / 2}^{N / 2} {B}_{n} sin ( - {K}_{x} ( i ) Δ n ) \vert \leq T ;$$
in the case where the first-type equation is a second-order partial differential equation and the finite difference scheme is not a staggered-grid finite difference, the determining whether the values, from 0 to the current discrete value, of the discrete variable Kₓ(i) in the finite difference scheme controlled by the current temporary coefficients meet the first condition, is performed by utilizing the following objective function:
$$E ( {K}_{x } ( i ) , T ) ≡ {max}_{0 \leq {k}_{x} ( i )} \vert - {{K}_{x} ( i )}^{2} {Δ}^{2} - {\sum }_{n = - N / 2}^{N / 2} {B}_{n} cos ( n {K}_{x} ( i ) Δ ) \vert \leq T ;$$
and
in the case where the first-type equation is a first-order partial differential equation and the finite difference scheme is a staggered-grid finite difference, the determining whether the values, from 0 to the current discrete value, of the discrete variable Kₓ(i) in the finite difference scheme controlled by the current temporary coefficients {Bₙ} meet the first condition, is performed by utilizing the following objective function:
$$E ( {K}_{x } ( i ) , T ) ≡ {max}_{0 \leq {k}_{x} ( i )} \vert - {K}_{x} ( i ) Δ - {\sum }_{n = - N / 2}^{N / 2} {b}_{n} sin [ ( 0.5 - n ) {K}_{x} ( i ) Δ ] \vert \leq T ;$$
where, Δ is a space grid spacing of a seismic source point velocity model.

12. The method according to claim 1, wherein
in the case where the first-type equation is a first-order partial differential equation and the finite difference scheme is not a staggered-grid finite difference,
first-type optimization coefficients bₙ for controlling a fourth-order finite difference scheme comprise: b₋₂, b₋₁, b₀, b₁, b₂, where, 0.0834≦b₋₂≦0.1985, and −0.1985≦b₂≦−0.0834;
first-type optimization coefficients bₙ for controlling a sixth-order finite difference scheme comprise: b₋₃, b₋₂, b₋₁, b₀, b₁, b₂, b₃, where, −0.0357≦b₋₃≦−0.0167, 0.1501≦b₋₂≦0.2912, −0.2912≦b₂≦−0.1501 and 0.0167≦b₃≦0.0357;
first-type optimization coefficients bₙ for controlling an eighth-order finite difference scheme comprise: b₋₄, b₋₃, b₋₂, b₋₁, b₀, b₁, b₂, b₃, b₄, where, 0.0036≦b₋₄≦0.0097, −0.0669≦b₋₃≦−0.0381, 0.2001≦b₋₂≦0.3698, −0.3698≦b₂≦−0.2001, 0.0381≦b₃≦0.0669 and −0.0097≦b₄≦−0.0036;
first-type optimization coefficients bₙ for controlling a tenth-order finite difference scheme comprise: b₋₅, b₋₄, b₋₃, b₋₂, b₋₁, b₀, b₁, b₂, b₃, b₄, b₅, where, −0.0078≦b₋₅≦−0.0008, 0.01≦b₋₄≦0.0299, −0.1337≦b₋₃≦−0.0596, 0.2381≦b₋₂≦0.3325, −0.3325≦b₂≦−0.2381, 0.0596≦b₃≦0.1337, −0.0299≦b₄≦−0.01, and 0.0008≦b₅≦0.0078; and
first-type optimization coefficients bₙ for controlling a twelfth-order finite difference scheme comprise: b₋₆, b₋₅, b₋₄, b₋₃, b₋₂, b₋₁, b₀, b₁, b₂, b₃, b₄, b₅ and b₆, where, 0.0001≦b₋₆≦0.0071, −0.0148≦b₋₅≦−0.0026, 0.0179≦b₋₄≦0.0588, −0.1527≦b₋₃≦−0.0794, 0.2679≦b₋₂≦0.3766, −0.3766≦b₂≦−0.2679, 0.0794≦b₃≦0.1527, −0.0588≦b₄≦−0.0179, 0.0026≦b₅≦0.0148, and −0.0071≦b₆≦−0.0001;
in the case where the first-type equation is a first order partial differential equation and the finite difference scheme is a staggered-grid finite difference,
first-type optimization coefficients bₙ for controlling a fourth-order staggered-grid finite difference scheme comprise: b₋₁, b₁, b₂, where, 0.04167≦b₋₁≦0.0913 and 0.0913≦b₂≦−0.04167;
first-type optimization coefficients bₙ for controlling a sixth-order staggered-grid finite difference scheme comprise: b₋₂, b₋₁, b₁, b₂, b₃, where, −0.0761≦b₋₂≦−0.0047, 0.0652≦b₋₁≦0.1820, −0.1820≦b₂≦−0.0652 and 0.0047≦b₃≦0.0761;
first-type optimization coefficients bₙ for controlling an eighth-order staggered-grid finite difference scheme comprise: b₋₃, b₋₂, b₋₁, b₁, b₂, b₃, b₄, where, 0.0007≦b₋₃≦0.0034, −0.0188≦b₋₂≦−0.0096, 0.0798≦b₋₁≦0.1465, −0.1465≦b₂≦−0.0798, 0.0096≦b₃≦0.0188 and −0.0034≦b₄≦−0.0007;
first-type optimization coefficients bₙ for controlling a tenth-order staggered-grid finite difference scheme comprise: b₋₄, b₋₃, b₋₂, b₋₁, b₁, b₂, b₃, b₄, b₅, where, −0.0088≦b₋₄≦−0.0002, 0.0018≦b₋₃≦0.0084, −0.0139≦b₋₂≦−0.0298, 0.0898≦b₋₁≦0.1969, −0.1969≦b₂≦−0.0898, 0.0139≦b₃≦0.0298, −0.0084≦b₄≦−0.0018 and 0.0002≦b₅≦0.0088; and
first-type optimization coefficients bₙ for controlling a twelfth-order staggered-grid finite difference scheme comprise: b₋₅, b₋₄, b₋₃, b₋₂, b₋₁, b₁, b₂, b₃, b₄, b₅, b₆, where 0.0002≦b₋₅≦0.009, −0.0046≦b₋₄≦−0.0004, 0.0030≦b₋₃≦0.0979, −0.0599≦b₋₂≦−0.0175, 0.0970≦b₋₁≦0.1953, −0.1953≦b₂, −0.0970, 0.0175≦b₃≦0.0599, −0.0979≦b₄≦−0.0030, 0.0004≦b₅≦0.0046 and −0.009≦b₆≦−0.0002;
in the case where the first-type equation is a second-order partial differential equation and the finite difference scheme is not a staggered-grid finite difference,
first-type optimization coefficients bₙ for controlling a fourth-order finite difference scheme comprise: b₋₂, b₋₁, b₀, b₁, b₂, where, −0.1648≦b₋₂≦−0.0834 and 0.1648≦b₂≦0.0834;
first-type optimization coefficients bₙ for controlling a sixth-order finite difference scheme comprise: b₋₃, b₋₂, b₋₁, b₀, b₁, b₂, b₃, where, 0.0112≦b₋₃≦0.0373, −0.3018≦b₋₂≦−0.1510, −0.3018≦b₂≦−0.1510 and 0.0112≦b₃≦0.0373;
first-type optimization coefficients bₙ for controlling an eighth-order finite difference scheme comprise: b₋₄, b₋₃, b₋₂, b₋₁, b₀, b₁, b₂, b₃, b₄, where, −0.0086≦b₋₄≦−0.0018, 0.0254≦b₋₃≦0.0585, −0.3855≦b₋₂≦−0.2001, −0.3855≦b₂≦−0.2001, 0.0254≦b₃≦0.0585 and −0.0086≦b₄≦−0.0018;
first-type optimization coefficients bₙ for controlling a tenth-order finite difference scheme comprise: b₋₅, b₋₄, b₋₃, b₋₂, b₋₁, b₀, b₁, b₂, b₃, b₄, b₅, where, 0.0004≦b₋₅≦0.0038, −0.0188≦b₋₄≦−0.0050, 0.0397≦b₋₃≦0.0837, −0.4826≦b₋₂≦−0.2384, −0.4826≦b₂≦−0.2384, 0.0397≦b₃≦0.0837, −0.0188≦b₄≦−0.0050 and 0.0004≦b₅≦0.0038; and
first-type optimization coefficients bₙ for controlling a twelfth-order finite difference scheme comprise: b₋₆, b₋₅, b₋₄, b₋₃, b₋₂, b₋₁, b₀, b₁, b₂, b₃, b₄, b₅, b₆, where, −0.0037≦b₋₆≦−0.0007, 0.0011≦b₋₅≦0.0077, −0.0327≦b₋₄≦−0.0090, 0.0530≦b₋₃≦0.1128, −0.3927≦b₋₂≦−0.2679, −0.3927≦b₂≦−0.2679, 0.0530≦b₃≦0.1128, −0.0327≦b₄≦−0.0090, 0.0011≦b₅≦0.0077 and −0.0037≦b₆≦−0.0007.

13. A device for acquiring optimization coefficients, comprising:
an initialization unit, adapted to set a value of an error limit T, set an initial value of a current discrete value, and set an output condition of the optimization coefficients;
a calculation unit, adapted to randomly generate at least one set of current temporary coefficients {Bₙ}, wherein, Bₙ⁰≦Bₙ≦Bₙ¹, Bₙ¹ is a floating upper limit preset for Bₙ, Bₙ⁰, is a floating lower limit preset for Bₙ, and wherein the number of Bₙ in the current temporary coefficients {Bₙ} is decided by the order N that is adopted by a finite difference scheme;
a checking unit, adapted to:
determine whether values, from 0 to the current discrete value, of the discrete variable Kₓ(i) in the finite difference scheme controlled by the current temporary coefficients {Bₙ} meet a first condition; wherein, the first condition is that a difference E between an ideal value and an actual value is less than or equal to the preset error limit T, the ideal value is a result (jKₓ(i)^{C} of a Fourier transform of a space partial derivative of a first-type equation, the actual value is a result of a Fourier transform, which uses the finite difference scheme controlled by the current temporary coefficients {Bₙ}, of the space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit; and
if it is determined that the values, from 0 to the current discrete value, of the discrete variable Kₓ(i) in the finite difference scheme controlled by the current temporary coefficients {Bₙ} meet the first condition,
send the current temporary coefficients {Bₙ} to an acquisition unit, and trigger the acquisition unit to operate;
if it is determined that the values, from 0 to the current discrete value, of the discrete variable Kₓ(i) in the finite difference scheme controlled by the current temporary coefficients {Bₙ} do not meet the first condition,
send the current temporary coefficients {Bₙ} to an interference unit, and trigger the interference unit to operate;
an acquisition unit, adapted to:
add the current temporary coefficients {Bₙ} into a first-type result to be selected; and
acquire an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, wherein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;
an interference unit, adapted to:
determine whether the output condition of the optimization coefficients is met; and
if the output condition of the optimization coefficients is not met,
adjust the current temporary coefficients {Bₙ} on the current basis of the current temporary coefficients {Bₙ}, wherein values of the adjusted temporary coefficients {Bₙ} are in a range from the floating upper limit to the floating lower limit preset for {Bₙ}; update the current temporary coefficients {Bₙ} to the values of the adjusted current temporary coefficients {Bₙ}; and send the current temporary coefficients {Bₙ} to the checking unit, and trigger the checking unit to operate;
if the output condition of the optimization coefficients is met,
trigger an output unit to operate; and
an output unit, adapted to select, from the first-type result to be selected, the current temporary coefficients {Bₙ} which have a maximum accuracy coverage range, as first-type optimization coefficients {bₙ}.

14. A method for simulating seismic wave field based on optimization coefficients, comprising:
acquiring data of wave activated by a seismic source point, wherein, the data of wave activated by the seismic source point comprises at least a wave velocity of a model medium, space coordinates of the seismic source point and time coordinates of the seismic source point;
acquiring a first-type equation involved in simulation for the seismic wave field activated by the seismic source point; and
simulating the seismic wave field activated by the seismic source point by applying a finite difference scheme controlled by the first-type optimization coefficients {bₙ} that are acquired by a method for acquiring optimization coefficients, by using the data of wave activated by the seismic source point as input data of the first-type equation;
wherein the method for acquiring optimization coefficients comprises: an initialization step, a calculation step, a checking step, an acquisition step, an interference step, and an output step, wherein,
the initialization step comprises:
setting a value of an error limit T;
setting an initial value of a current discrete value; and
setting an output condition of the optimization coefficients;
the calculation step comprises:
randomly generating at least one set of current temporary coefficients {Bₙ}, wherein, Bₙ⁰≦Bₙ≦Bₙ¹, Bₙ¹ is a floating upper limit preset for Bₙ, Bₙ⁰ is a floating lower limit preset for Bₙ, and wherein the number of Bₙ in the current temporary coefficients {Bₙ} is decided by the order N that is adopted by a finite difference scheme;
the checking step comprises:
determining whether values, from 0 to the current discrete value, of a discrete variable Kₓ(i) in the finite difference scheme controlled by the current temporary coefficients {Bₙ} meet a first condition;
wherein, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of a space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;
if it is determined that the values, from 0 to the current discrete value, of the discrete variable Kₓ(i) in the finite difference scheme controlled by the current temporary coefficients {Bₙ} meet the first condition, entering the acquisition step;
if it is determined that the values, from 0 to the current discrete value, of the discrete variable Kₓ(i) in the finite difference scheme controlled by the current temporary coefficients {Bₙ} do not meet the first condition, entering the interference step;
the acquisition step comprises:
adding the current temporary coefficients {Bₙ} into a first-type result to be selected; and
acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, wherein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;
the interference step comprises:
determining whether the output condition of the optimization coefficients is met; and
in the case that the output condition of the optimization coefficients is not met, adjusting the current temporary coefficients {Bₙ} on a current basis of the current temporary coefficients {Bₙ}, wherein the values of the adjusted current temporary coefficients {Bₙ} are in a range from the floating upper limit to the floating lower limit preset for {Bₙ}; and updating the current temporary coefficients {Bₙ} to the values of the adjusted current temporary coefficients {Bₙ}, and entering the checking step; and
in the case that the output condition of the optimization coefficients is met, entering the output step; and
the output step comprises:
selecting, from the first-type result to be selected, the current temporary coefficients {Bₙ} which have a maximum accuracy coverage range, as first-type optimization coefficients {bₙ}.

15. A device for simulating seismic wave field based on optimization coefficients, comprising:
a pre-processing unit, adapted to acquire data of wave activated by a seismic source point, wherein the data of wave activated by the seismic source point comprises at least a wave velocity of a model medium, space coordinates of the seismic source point and time coordinates of the seismic source point; and acquire a first-type equation involved in simulation for the seismic wave field activated by the seismic source point; and
a simulation unit, adapted to simulate the seismic wave field activated by the seismic source point by applying a finite difference scheme controlled by the first-type optimization coefficients {bₙ} that are acquired by a method for acquiring optimization coefficients, by using the data of wave activated by the seismic source point as input data of the first-type equation;
wherein the method for acquiring optimization coefficients comprises: an initialization step, a calculation step, a checking step, an acquisition step, an interference step, and an output step, wherein,
the initialization step comprises:
setting a value of an error limit T;
setting an initial value of a current discrete value; and
setting an output condition of the optimization coefficients;
the calculation step comprises:
randomly generating at least one set of current temporary coefficients {Bₙ}, wherein, Bₙ⁰≦Bₙ≦Bₙ¹, Bₙ¹ is a floating upper limit preset for Bₙ, Bₙ⁰ is a floating lower limit preset for Bₙ, and wherein the number of Bₙ in the current temporary coefficients {Bₙ} is decided by the order N that is adopted by a finite difference scheme;
the checking step comprises:
determining whether values, from 0 to the current discrete value, of a discrete variable Kₓ(i) in the finite difference scheme controlled by the current temporary coefficients {Bₙ} meet a first condition;
wherein, the first condition is that a difference E between an ideal value and an actual value is less than or equal to the preset error limit T, the ideal value is a result (jKₓ(i))^{C} of a Fourier transform of a space partial derivative of a first-type equation, the actual value is a result of a Fourier transform, which uses the finite difference scheme controlled by the current temporary coefficients {Bₙ}, of a space partial derivative of the first-type equation when the discrete variable Kₓ(i) takes the ith discrete value, the range of the discrete value of the discrete variable Kₓ(i) is 0≦Kₓ(i)<π, C is the order of the space partial derivative of the first-type equation, and j=\sqrt{−1} is imaginary unit;
if it is determined that the values, from 0 to the current discrete value, of the discrete variable Kₓ(i) in the finite difference scheme controlled by the current temporary coefficients {Bₙ} meet the first condition, entering the acquisition step;
if it is determined that the values, from 0 to the current discrete value, of the discrete variable Kₓ(i) in the finite difference scheme controlled by the current temporary coefficients {Bₙ} do not meet the first condition, entering the interference step;
the acquisition step comprises:
adding the current temporary coefficients {Bₙ} into a first-type result to be selected; and
acquiring an accuracy coverage range of the current temporary coefficients {Bₙ}, according to the determining whether the values, from 0 to the current discrete value, of the discrete variable Kₓ(i) in the finite difference scheme controlled by the current temporary coefficients {Bₙ} meet the first condition, wherein a maximum discrete value of the discrete variable Kₓ(i) in the finite difference scheme controlled by the current temporary coefficients {Bₙ} with the maximum discrete value satisfying a condition that any discrete value in the accuracy coverage range that is taken by the discrete variable Kₓ(i) meets the first condition;
the interference step comprises:
determining whether the output condition of the optimization coefficients is met; and
in the case that the output condition of the optimization coefficients is not met, adjusting the current temporary coefficients {Bₙ} on a current basis of the current temporary coefficients {Bₙ}, wherein the values of the adjusted current temporary coefficients {Bₙ} are in a range from the floating upper limit to the floating lower limit preset for {Bₙ}; and updating the current temporary coefficients {Bₙ} to the values of the adjusted current temporary coefficients {Bₙ}, and entering the checking step; and
in the case that the output condition of the optimization coefficients is met, entering the output step; and
the output step comprises:
selecting, from the first-type result to be selected, the current temporary coefficients {Bₙ} which have a maximum accuracy coverage range, as first-type optimization coefficients {bₙ}.
